(19) United States
(12) Patent Application Publication
(10) Pub. No.: US 2014/0316054 A1
(43) Pub. Date: Oct. 23, 2014

(54) METHOD OF FORMING FILM

(71) Applicant: Tokyo Ohka Kogyo Co., Ltd., Kawasaki-shi (JP)

(72) Inventors: Shinji Kumada, Kawasaki-shi (JP); Toshiaki Tachi, Kawasaki-shi (JP); Makiko Irie, Kawasaki-shi (JP); Shota Katayama, Kawasaki-shi (JP)

(73) Assignee: Tokyo Ohka Kogyo Co., Ltd., Kawasaki-shi (JP)

(21) Appl. No.: 14/255,273

(22) Filed: Apr. 17, 2014

(30) Foreign Application Priority Data
Apr. 23, 2013 (JP) 2013-090756

(51) Int. Cl. C09D 133/14; C09D 129/08; C09D 161/06

(52) U.S. Cl. CPC C09D 133/14; C09D 161/06; C09D 129/08; C08K 5/101
USPC 524/553; 427/240; 524/594; 524/577; 524/558

(57) ABSTRACT

A method of forming a film including forming a film on a substrate by coating a composition for forming a film containing a solvent and a resin by a spin coating method, in which a maximum radius among the radii from the center to the outer periphery of the substrate is 150 mm or more and a thickness of the film is 50 μm or more, a vapor pressure of the solvent at 25° C. is 0.4 kPa or less, and a viscosity of the solvent measured by a Cannon-Fenske viscometer at 25° C. is 1.5 mPa·s or less.

### CROSS-REFERENCE TO RELATED APPLICATIONS

The present application claims priority under 35 U.S.C. §119 (a)-(d) to Japanese Patent Application No. 2013-090756, filed Apr. 23, 2013, the entire content of which is incorporated herein by reference.

### BACKGROUND OF THE INVENTION

1. Field of the Invention

The present invention relates to a method of forming a film which forms a film on a substrate by coating a composition for forming a film containing a specific solvent and a resin on a substrate using a spin coating method and to a substrate with a film which includes a film formed by the method of forming a film.

2. Related Art

In recent years, along with downsizing of electronic devices, a technology of mounting a semiconductor package with high density progresses, to improve the mounting technology with high density based on a two-dimensional mounting technology and a three-dimensional mounting technology by mounting a thin film of a package with multiple pins, reduction in package size, and a flip-chip system. In such mounting technology with high density, for example, a protruding electrode (mounting terminal) such as a bump protruding on a package or a metal post which connects a mounting terminal with a rewiring extended from a peripheral terminal on a wafer are disposed as a connection terminal on a substrate with high precision.

As a method of forming a protruding electrode or a metal post as described above, a method of forming a thick film with a thickness of 50 μm or more on a processed surface of a substrate by a spin coating method, patterning the film by selectively removing a predetermined site in the film, embedding a conductor such as copper in a portion of the removed film in the film by plating, and removing a film in the surrounding.

In such a method, a film having a uniform thickness is required to be formed on a substrate in order to form a protruding electrode or a metal post with excellent dimension precision. As a composition for forming a film with a uniform thickness on a substrate, a composition containing an acid generator, a resin soluble in alkali by an action of an acid, and a non-ionic fluorine-containing compound such as a non-ionic fluorine-containing surfactant formed of a perfluoroalkyl ethylene oxide adduct, or a non-ionic fluorine-containing organosiloxane-based compound which has a perfluoropolyether group and a polyoxyalkylene type polyether bond is proposed (see JP-A-2012-163949). In the example of JP-A-2012-163949, a film is formed by coating a composition for forming a film on a substrate using a spin coating method.

### SUMMARY OF THE INVENTION

However, there is a problem with cost because the composition disclosed in JP-A-2012-163949 necessarily contains an expensive surfactant which is a fluorine-containing compound. Further, in JP-A-2012-163949, in regard to uniformity of the thickness of the film formed by coating a composition for forming a film using a spin coating method, the uniformity only in a case of using a substrate having a diameter of 200 mm (8 inches) is evaluated. However, the size of a substrate which is the target of forming a film tends to become equal to or larger than 300 mm (12 inches) from the demand of improving productivity of a semiconductor package or reducing the production cost. Further, it is difficult to form a film with a uniform thickness using a spin coating method as a substrate becomes larger.

In light of the problem described above, even in a case in which an expensive additive such as a surfactant formed of a fluorine-containing compound is not added to a composition for forming a film, a method of forming a film which is capable of forming a thick film with a uniform thickness of 50 μm or larger on a large substrate having a diameter of 300 mm or more using a spin coating method is demanded.

The present invention provides a method of forming a film which is capable of forming a thick film having a uniform film thickness of 50 μm or more on a large substrate having a diameter of 300 mm or more using a spin coating method even in a case where an expensive additive is not added to a composition for forming a film. Further, the present invention provides a substrate with a film including a film formed by the method of forming a film.

As a result of intensive investigation in order to solve the above-described problem, the present inventors found that the problem can be solved by coating a composition for forming a film which contains a resin and a solvent having viscosity and vapor pressure in a predetermined range on a large substrate having a diameter of 300 mm or more such that the thickness thereof becomes 50 μm or more using a spin coating method, thereby completing the present invention. Specifically, the present invention provides the following.

According to a first aspect of the present invention, there is provided a method of forming a film including forming a film on a substrate by coating a composition for forming a film containing a solvent and a resin by a spin coating method, in which a maximum radius among the radii from the center to the outer periphery of the substrate is 150 mm or more and a thickness of the film is 50 μm or more, a vapor pressure of the solvent at 25° C. is 0.4 kPa or less, and a viscosity of the solvent measured by a Cannon-Fenske viscometer at 25° C. is 1.5 mPa·s or less.

According to a second aspect of the present invention, there is provided a substrate with a film including a film formed by the method of forming a film according to the first aspect.

According to the present invention, it is possible to provide a method of forming a film, which is capable of forming a thick film having a uniform thickness of 50 μm or more on a large substrate with a diameter of 300 mm or more using a spin coating method even when an expensive additive is not added to a composition for forming a film, and a substrate with a film which includes a film formed by the method of forming a film.

### DETAILED DESCRIPTION OF THE INVENTION

### Method of Forming Film

In regard to a method of forming a film according to the present invention, a film with a thickness of 50 μm or more is formed by coating a composition for forming a film containing a solvent (A) and a resin (B) on a substrate using a spin coating method. When a film is formed, a substrate having the maximum radius among the radii from the center to the outer periphery of the substrate is 150 mm or more is used as a substrate. In the solvent (A) contained in the composition for forming a film, the vapor pressure at 25° C. is 0.4 kPa or less and the viscosity measured by a Cannon-Fenske viscometer at 25° C. is 1.5 mPa·s or less. Hereinafter, the composition for forming a film and the method of coating the composition for forming a film will be described in order.

### [Composition for Forming a Film]

The composition for forming a film necessarily contains the solvent (A) and the resin (B). Hereinafter, an indispensable component or an optional component contained in the composition for forming a film and a method of preparing the composition for forming a film will be described.

### [Solvent (A)]

The composition for forming a film contains the solvent (A) whose vapor pressure at 25° C. is 0.4 kPa or less and the viscosity measured by a Cannon-Fenske viscometer at 25° C. is 1.5 mPa·s or less. The vapor pressure of the solvent (A) is vapor pressure of the solvent (A) alone. The vapor pressure of the solvent (A) can be measured by a conventional method. The vapor pressure thereof can be measured in the same manner as the vapor pressure of the solvent alone even when the solvent (A) is formed by mixing a plurality of solvents.

When the composition for forming a film is coated on a substrate having a large diameter with a spin coating method, the thickness of the film tends to be uneven because of the influence of change in viscosity of the composition for forming a film due to volatilization of the solvent while the composition for forming a film is diffused to the entire surface of the substrate. However, when the vapor pressure of the solvent (A) contained in the composition for forming a film is 0.4 kPa or less at 25° C., the solvent (A) is volatilized from the composition for forming a film which diffuses on the substrate with an appropriate speed not inhibiting the uniform diffusion of the composition for forming a film on the substrate even in a case of coating the composition for forming a film on the substrate with a large diameter using a spin coating method. As a result, a film with a uniform thickness can be formed.

In addition, it is necessary to raise the solid content concentration of the composition for forming a film to a certain extent when a thick film is formed. In such a way, the viscosity of the composition for forming a film tends to increase to a certain extent. However, when a film is formed on a substrate having a large diameter using a spin coating method, the substrate rotates at a low speed due to the size of the substrate. Accordingly, if the viscosity of the composition for forming a film is high, the composition for forming a film is difficult to uniformly diffuse on the substrate, which makes it difficult to form a film with a uniform thickness. On the other hand, it is difficult to form a film with a desired thickness in a case of reducing the viscosity of the composition for forming a film by adjusting the solid content concentration in consideration of the uniformity of the film thickness.

However, when the solvent (A) whose viscosity measured under a predetermined condition is 1.5 mPa·s or less is allowed to be contained in the composition for forming a film, it is possible to suppress the viscosity of the composition for forming a film to be low even by setting the solid content concentration of the composition for forming a film to be high to a certain extent. As a result, contradicting problems which are the formation of a film with uniform thickness and the formation of thick film using a spin coating method are solved.

Specific examples of the solvent (A) having viscosity and the predetermined vapor pressure described above may include 3-methoxybutyl acetate (MA), 2-heptanone (HP), dipropylene glycol dimethyl ether, and dipropylene glycol methyl-n-propyl ether.

The content of the solvent (A) in the composition for forming a film is not particularly limited as long as a film with a desired thickness of 50 μm or more can be formed using a spin coating method on a substrate having a maximum radius of 150 mm or more among the radii from the center to the outer periphery of the substrate. The solvent (A) is used in such an amount that the solid content concentration of the composition for forming a film typically becomes 45% by mass to 65% by mass and preferably 50% by mass to 60% by mass.

### [Resin (B)]

The type of the resin (B) contained in the composition for forming a film is not particularly limited as long as the resin is soluble in the solvent (A). The content of the resin (B) in the composition for forming a film is preferably 40% by mass to 65% by mass and more preferably 45% by mass to 60% by mass. In addition, the mass average molecular weight of the resin (B) is preferably 10,000 to 400,000, more preferably 30,000 to 300,000, and still more preferably 40,000 to 250,000 from a viewpoint that a film with a thickness of 50 μm or more is easily formed to have a uniform thickness.

As the resin (B), since patterning a film or peeling a film from a substrate is easily performed, an alkali-soluble resin or a resin whose solubility in alkali increases under the action of acid is preferable. When the resin whose solubility in alkali increases under the action of acid is blended with the composition for forming a film together with a photoacid generator described below, by selectively exposing the film to be formed, an exposed portion in the film is allowed to be soluble in alkali. In this case, a pattern in a desired shape can be formed by bringing the selectively exposed film into contact with an alkaline developer solution and removing the exposed portion. The resin whose solubility in alkali increases under the action of acid is not necessarily used together with a photoacid generator. Hereinafter, the alkali-soluble resin and the resin whose solubility in alkali increases under the action of acid will be described.

### Alkali-Soluble Resin

The alkali-soluble resin means that a resin film having a thickness of 1 μm is formed by a resin solution (solvent: propylene glycol monomethyl ether acetate) having a resin concentration of 20% by mass and 0.01 μm or more in thickness thereof is dissolved when the film is immersed in an aqueous solution of 2.38% by mass of tetramethyl ammonium hydroxide (TMAH) at 23° C. for 1 minute. Preferred examples of the alkali-soluble resin may include a novolac resin, a polyhydroxystyrene resin, and an acrylic resin. Among these resins, an acrylic resin is preferable from the viewpoint that characteristics of the composition for forming a film and the formed resin can be easily adjusted by selection of a constituent unit. Hereinafter, a novolac resin, a polyhydroxystyrene resin, and an acrylic resin will be described in this order.

### (Novolac Resin)

The novolac resin can be obtained by performing addition condensation of, for example, an aromatic compound (hereinafter, simply referred to as “phenols”) including a phenolic hydroxyl group and aldehydes in the existence of an acid catalyst.

Examples of the phenols may include phenol, o-cresol, m-cresol, p-cresol, o-ethylphenol, m-ethylphenol, p-ethylphenol, o-butylphenol, m-butylphenol, p-butylphenol, 2,3-xylenol, 2,4-xylenol, 2,5-xylenol, 2,6-xylenol, 3,4-xylenol, 3,5-xylenol, 2,3,5-trimethylphenol, 3,4,5-trimethylphenol, p-phenylphenol, resorcinol, hydroquinone, hydroquinone monomethyl ether, pyrogallol, phloroglycinol, hydroxyl diphenyl, bisphenol A, gallic acid, gallic acid ester, α-naphthol, and β-naphthol.

Examples of the aldehydes may include formaldehyde, furfural, benzaldehyde, nitrobenzaldehyde, and acetaldehyde.

The catalyst for reaction of addition condensation is not particularly limited, but examples of the acid catalyst to be used may include hydrochloric acid, nitric acid, sulfuric acid, formic acid, oxalic acid, and acetic acid.

In addition, it is possible to further improve flexibility of the novolac resin by using o-cresol, substituting a hydrogen atom of a hydroxyl group in a resin with another substituent, or using bulky aldehydes.

### (Polyhydroxystyrene Resin)

Example of a hydroxystyrene-based compound constituting a polyhydroxystyrene resin may include p-hydroxystyrene, α-methylhydroxystyrene, and α-ethylhydroxystyrene.

In addition, a copolymer with a styrene resin is preferable as a polyhydroxystyrene resin. Examples of the styrene-based compound constituting such a styrene resin may include styrene, chlorostyrene, chloromethylstyrene, vinyltoluene, and α-methylstyrene.

### (Acrylic Resin)

An acrylic resin contains a constituent unit derived from (meth)acrylic acid or (meth)acrylic acid derivative such as (meth)acrylic acid, (meth)acrylic acid ester, or (meth)acrylic acid amide, and is not particularly limited as long as the acrylic resin has predetermined alkali solubility.

It is preferable that the acrylic resin contain a constituent unit derived from a polymerizable compound containing a carboxyl group. Examples of the polymerizable compound including a carboxyl group may include monocarboxylic acids such as acrylic acid, methacrylic acid, and crotonic acid; dicarboxylic acids such as maleic acid, fumaric acid, and itaconic acid; and a compound including a carboxyl group and an ester bond such as 2-methacryloyloxyethyl succinic acid, 2-methacryloyloxyethyl maleic acid, 2-methacrylolyoxyethyl phthalic acid, or 2-methacryloyloxyethyl hexahydrophthalic acid. The polymerizable compound including a carboxyl group is preferably acrylic acid or methacrylic acid. These polymerizable compounds may be used alone or in combination of two or more kinds thereof.

It is preferable that the acrylic resin contain a constituent unit derived from a polymerizable compound including a carboxyl group and a constituent unit derived from a linear alkyl ester having 3 to 12 carbon atoms of (meth)acrylic acid. When the acrylic resin contains such a unit, generation of bubbles in a film to be formed is easily suppressed.

Preferred specific examples of the linear alkyl ester having 3 to 12 carbon atoms of (meth)acrylic acid may include n-butyl(meth)acrylate, n-octyl(meth)acrylate, and n-decyl(meth)acrylate.

It is preferable that the acrylic acid contain a constituent unit derived from a polymerizable compound including a carboxyl group and a constituent unit derived from a linear alkyl ester having 3 to 12 carbon atoms of (meth)acrylic acid as described above.

In addition, the acrylic resin may contain a constituent unit derived from a polymerizable compound other than the linear alkyl ester having 3 to 12 carbon atoms of (meth)acrylic acid and a polymerizable compound including a carboxyl group.

Examples of such a polymerizable compound may include (meth)acrylic acid derivatives containing an ether bond and an ester bond such as 2-methoxyethyl (meth)acrylate, methoxytriethylene glycol (meth)acrylate, 3-methoxybutyl (meth)acrylate, ethylcarbitol (meth)acrylate, phenoxypolyethylene glycol (meth)acrylate, methoxypolypropylene glycol (meth)acrylate, and tetrahydrofurfuryl (meth)acrylate; (meth)acrylic acid hydroxyalkyl esters such as 2-hydroxyethyl (meth)acrylate and 2-hydroxypropyl(meth)acrylate; (meth)acrylic acid esters including a group which contains an aromatic group such as phenyl(meth)acrylate and benzyl(meth)acrylate; dicarboxylic acid diesters such as diethyl maleate and dibutyl fumarate; vinyl group-containing aromatic compounds such as styrene, α-methylstyrene, chlorostyrene, chloromethylstyrene, vinyltoluene, hydroxystyrene, α-methylhydroxystyrene, and α-ethylhydroxystyrene; vinyl group-containing aliphatic compounds such as vinyl acetate; conjugated diolefins such as butadiene and isoprene; nitrile group-containing polymerizable compounds such as acrylonitrile and methacrylonitrile; chlorine-containing polymerizable compounds such as vinyl chloride and vinylidene chloride; and amide bond-containing polymerizable compounds such as acrylamide and methacrylamide. Resin whose solubility in alkali increases under action of acid

A resin whose solubility in alkali increases under the action of acid can be selected from various resins blended in a photosensitive resin composition in the related art. Examples of the preferred resin as the resin whose solubility in alkali increases under the action of acid may include a novolac resin (B1), a polyhydroxystyrene resin (B2), and an acrylic resin (B3) which have specific structures as follows. Hereinafter, the novolac resin (B1), the polyhydroxystyrene resin (B2), and the acrylic resin (B3) will be described in order.

### (Novolac Resin (B1))

As the novolac resin (B1), a resin containing a constituent unit represented by the following formula (b1) can be used.

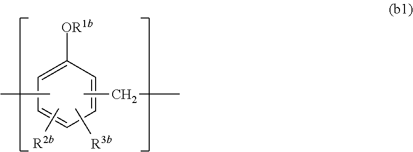

In the formula (b1), R^{1b} represents an acid-dissociative dissolution-controlling group, and R^{2b} and R^{3b} each independently represent a hydrogen atom or an alkyl group having 1 to 6 carbon atoms.

As the acid-dissociative dissolution-controlling group represented by R^{1b}, a group represented by the following formulae (b2) and (b3), a linear, branched, or cyclic alkyl group having 1 to 6 carbon atoms, a vinyloxyethyl group, a tetrahydropyranyl group, a tetrafuranyl group, or a trialkylsilyl group is preferably used.

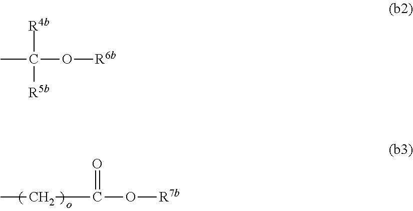

In the formulae (b2) and (b3), R^{4b} and R^{5b} each independently represent a hydrogen atom or a linear or branched alkyl group having 1 to 6 carbon atoms, R^{6b} represents a linear, branched, or cyclic alkyl group having 1 to 10 carbon atoms, R^{7b} represents a linear, branched, or cyclic alkyl group having 1 to 6 carbon atoms, and o represents 0 or 1.

Examples of the linear or branched alkyl group may include a methyl group, an ethyl group, a propyl group, an isopropyl group, an n-butyl group, an isobutyl group, a tert-butyl group, a pentyl group, an isopentyl group, and a neopentyl group. Further, examples of the cyclic alkyl group may include a cyclopentyl group or a cyclohexyl group.

Here, specific examples of the acid-dissociative dissolution-controlling group represented by the following formula (b2) may include a methoxyethyl group, an ethoxyethyl group, an n-propoxyethyl group, an isopropoxyethyl group, an n-butoxyethyl group, an isobutoxyethyl group, a tert-butoxyethyl group, a cyclohexyloxyethyl group, a methoxypropyl group, an ethoxypropyl group, a 1-methoxy-1-methyl-ethyl group, and a 1-ethoxy-1-methylethyl group. Further, specific examples of the acid-dissociative dissolution-controlling group represented by the formula (b3) may include a tert-butoxycarbonyl group and a tert-butoxycarbonylmethyl group. Further, examples of the trialkylsilyl group may include a group whose alkyl group has 1 to 6 carbon atoms such as a trimethylsilyl group, a tri-tert-butyldimethylsilyl group.

### (Polyhydroxystyrene Resin (B2))

As the polyhydroxystyrene resin (B2), a resin containing the constituent unit represented by the following formula (b4) can be used.

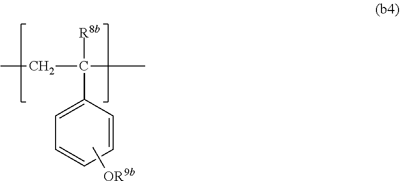

In the formula (b4), R^{8b} represents a hydrogen atom or an alkyl group having 1 to 6 carbon atoms and R^{9b} represents an acid-dissociative dissolution-controlling group.

The alkyl group having 1 to 6 carbon atoms is a linear, branched, or cyclic alkyl group having 1 to 6 carbon atoms. Examples of the linear or branched alkyl group may include a methyl group, an ethyl group, a propyl group, an isopropyl group, an n-butyl group, an isobutyl group, a tert-butyl group, a pentyl group, an isopentyl group, and a neopentyl group. Examples of the cyclic alkyl group may include a cyclopentyl group and a cyclohexyl group.

As the acid-dissociative dissolution-controlling group represented by R^{9b}, the same acid-dissociative dissolution-controlling group as the group exemplified in the formulae (b2) and (b3) can be used.

Moreover, the polyhydroxystyrene resin (B2) may contain another polymerizable compound as a constituent unit in order to appropriately control physical and chemical characteristics. Examples of such a polymerizable compound may include a conventional radical polymerizable compound or an anionic polymerizable compound. In addition, examples of such a polymerizable compound may include monocarboxylic acids such as acrylic acid, methacrylic acid, and crotonic acid; dicarboxylic acids such as maleic acid, fumaric acid, and itaconic acid; methacrylic acid derivatives including a carboxyl group and an ester bond such as 2-methacryloyloxyethyl succinic acid, 2-methacryloyloxyethyl maleic acid, 2-methacryloyloxyethyl phthalic acid, or 2-methacryloyloxyethyl hexahydrophthalic acid; (meth)acrylic acid alkyl esters such as methyl (meth)acrylate, ethyl (meth)acrylate, and butyl (meth)acrylate; (meth)acrylic acid hydroxyalkyl esters such as 2-hydroxyethyl (meth)acrylate and 2-hydroxypropyl (meth)acrylate; (meth)acrylic acid aryl esters such as phenyl (meth)acrylate and benzyl (meth)acrylate; dicarboxylic acid diesters such as diethyl maleate and dibutyl fumarate; vinyl group-containing aromatic compounds such as styrene, α-methylstyrene, chlorostyrene, chloromethylstyrene, vinyltoluene, hydroxystyrene, α-methylhydroxystyrene, and α-ethylhydroxystyrene; vinyl group-containing aliphatic compounds such as vinyl acetate; conjugated diolefins such as butadiene and isoprene; nitrile group-containing polymerizable compounds such as acrylonitrile and methacrylonitrile; chlorine-containing polymerizable compounds such as vinyl chloride and vinylidene chloride; and amide bond-containing polymerizable compounds such as acrylamide and methacrylamide.

As the acrylic resin (B3), a resin containing the constituent units represented by the following formulae (b5) to (b7) can be used.

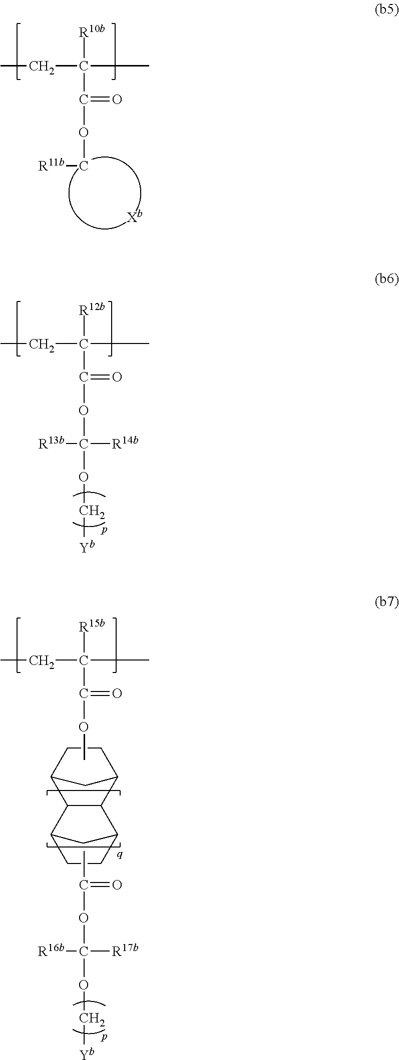

In the formulae (b5) to (b7), R^{10b} to R^{17b} each independently represent a hydrogen atom, a linear or branched alkyl group having 1 to 6 carbon atoms, a fluorine atom, or a linear or branched fluorinated alkyl group having 1 to 6 carbon atoms (provided that, R^{11b} does not represent a hydrogen atom), X^{b} forms a hydrocarbon ring having 5 to 20 carbon atoms together with carbon atoms to which X^{b} is bonded, Y^{b} represents an aliphatic cyclic group which may have a substituent or an alkyl group, p represents an integer of 0 to 4, and q represents 0 or 1.

Further, examples of the linear or branched alkyl group may include a methyl group, an ethyl group, a propyl group, an isopropyl group, an n-butyl group, an isobutyl group, a tert-butyl group, a pentyl group, an isopentyl group, and a neopentyl group. Furthermore, a fluorinated alkyl group is a group in which a part or the entireties of hydrogen atoms of the alkyl group are substituted with a fluorine atom.

R^{11b} is preferably a linear or branched alkyl group having 2 to 4 carbon atoms in terms of high contrast, excellent resolution and depth of focus, and R^{13b}, R^{14b}, R^{16b}, and R^{17b} are preferably hydrogen atoms or methyl groups.

X^{b} forms an aliphatic cyclic group having 5 to 20 carbon atoms together with carbon atoms to which X^{b} is bonded. Examples of such an aliphatic cyclic group may include a group in which one or more of hydrogen atoms are removed from polycycloalkane such as monocycloalkane, bicycloalkane, tricycloalkane, or tetracycloalkane. Specific examples thereof may include a group in which one or more of hydrogen atoms are removed from monocycloalkane such as cyclopentane, cyclohexane, cycloheptane, or cyclooctane; or polycycloalkane such as adamantane, norbornane, isobornane, tricyclodecane, or tetracyclododecane. Particularly, a group (which may further have a substituent) in which one or more of hydrogen atoms are removed from cyclohexane or adamantane is preferable.

Further, when the aliphatic cyclic group of X^{b} includes a substituent on the cyclic skeleton, examples of the substituent may include a polar group such as a hydroxyl group, a carboxy group, a cyano group, or an oxygen atom (═O) and a linear or branched alkyl group having 1 to 4 carbon atoms. As the polar group, an oxygen atom (═O) is particularly preferable.

Y^{b} is an aliphatic cyclic group or an alkyl group, and examples thereof may include a group in which one or more of hydrogen atoms are removed from monocycloalkane, polycycloalkane such as bicycloalkane, tricycloalkane, or tetracycloalkane. Specific examples thereof may include a group in which one or more of hydrogen atoms are removed from monocycloalkane such as cyclopentane, cyclohexane, cycloheptane, or cyclooctane; or polycycloalkane such as adamantane, norbornane, isobornane, tricyclodecane, or tetracyclododecane. Particularly, a group (which may further have a substituent) in which one or more of hydrogen atoms are removed from adamantane is preferable.

In addition, when the aliphatic cyclic group of Y^{b} includes a substituent on the cyclic skeleton, examples of the substituent may include a polar group such as a hydroxyl group, a carboxy group, a cyano group, or an oxygen atom (═O) and a linear or branched alkyl group having 1 to 4 carbon atoms. As the polar group, an oxygen atom (═O) is particularly preferable.

Moreover, when Yb is an alkyl group, a linear or branched alkyl group having 1 to 20 carbon atoms and preferably 6 to 15 carbon atoms is preferable. As such an alkyl group, an alkoxyalkyl group is particularly preferable, and examples of the alkoxyalkyl group may include a 1-methoxyethyl group, a 1-ethoxyethyl group, a 1-n-propoxyethyl group, a 1-isopropoxyethyl group, a 1-n-butoxyethyl group, a 1-isobutoxyethyl group, a 1-tert-butoxyethyl group, a 1-methoxypropyl group, a 1-ethoxypropyl group, a 1-methoxy-1-methyl-ethyl group, and a 1-ethoxy-1-methylethyl group.

Preferred specific examples of the constituent unit represented by the formula (b5) may include constituent units represented by the following formulae (b5-1) to (b5-33).

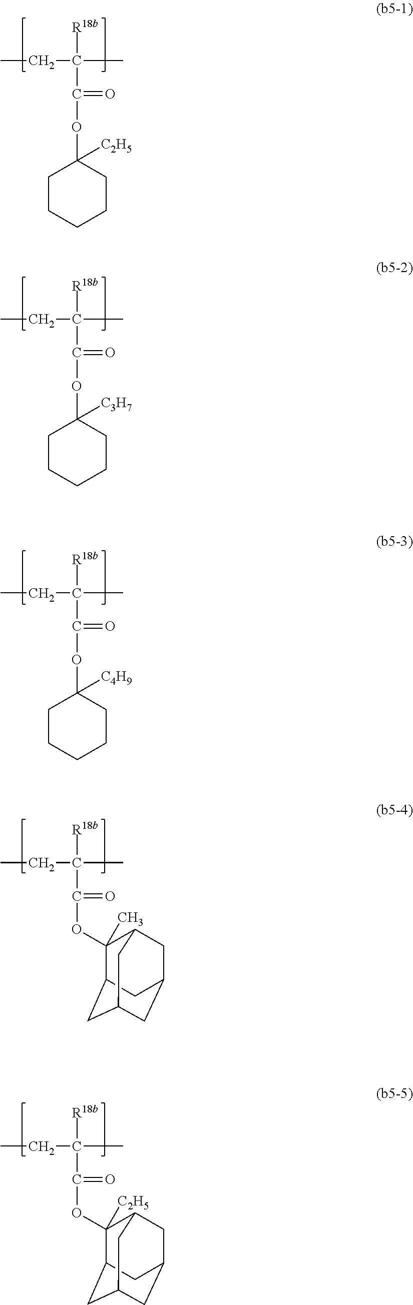

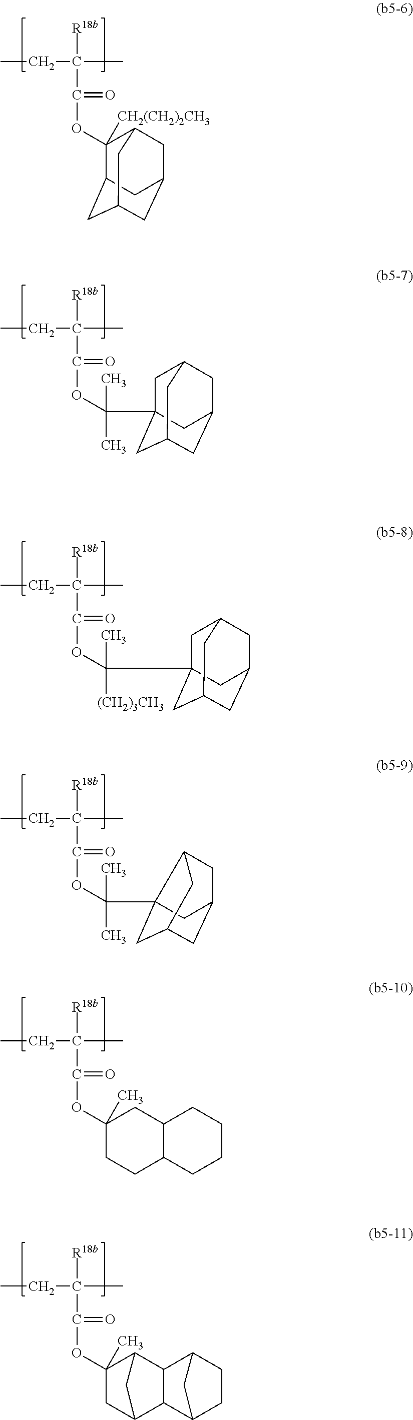

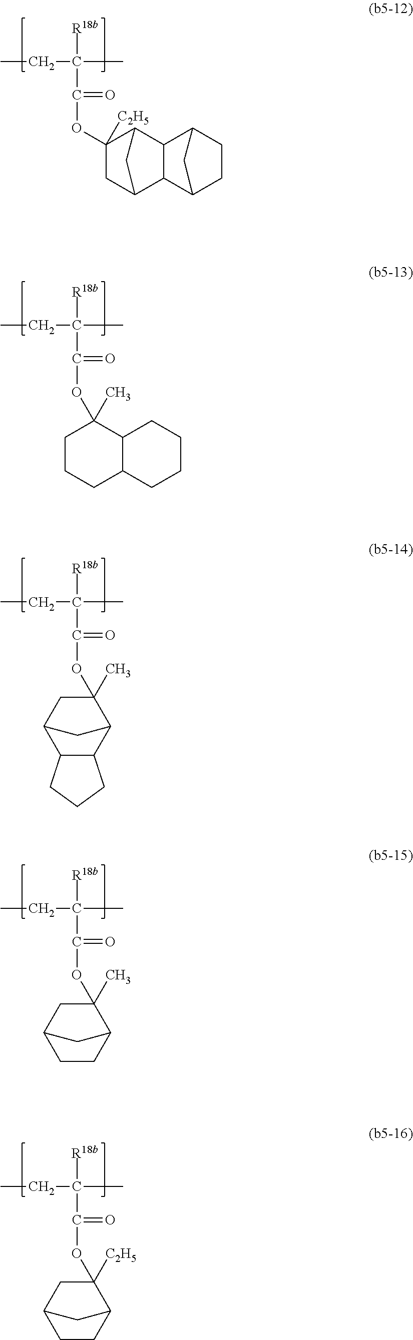

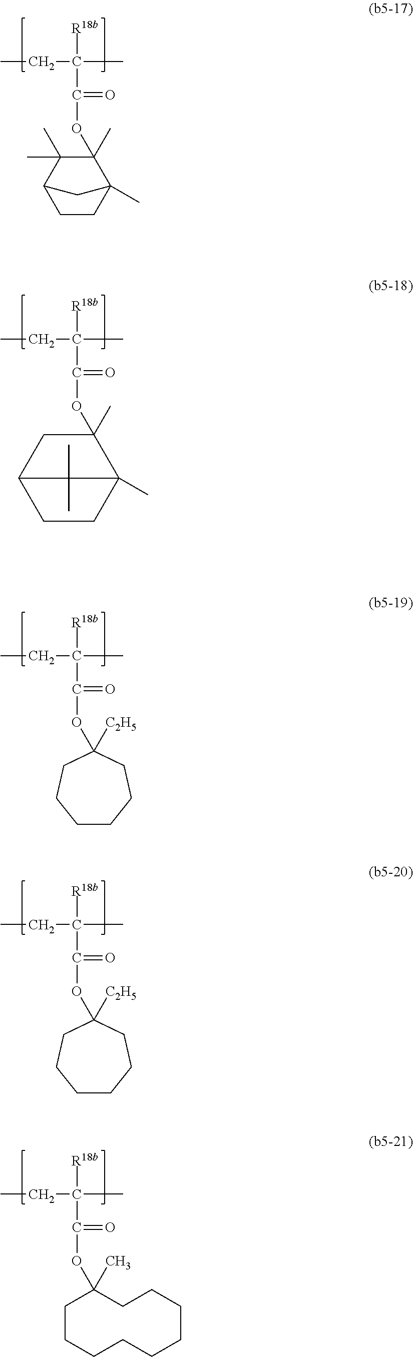

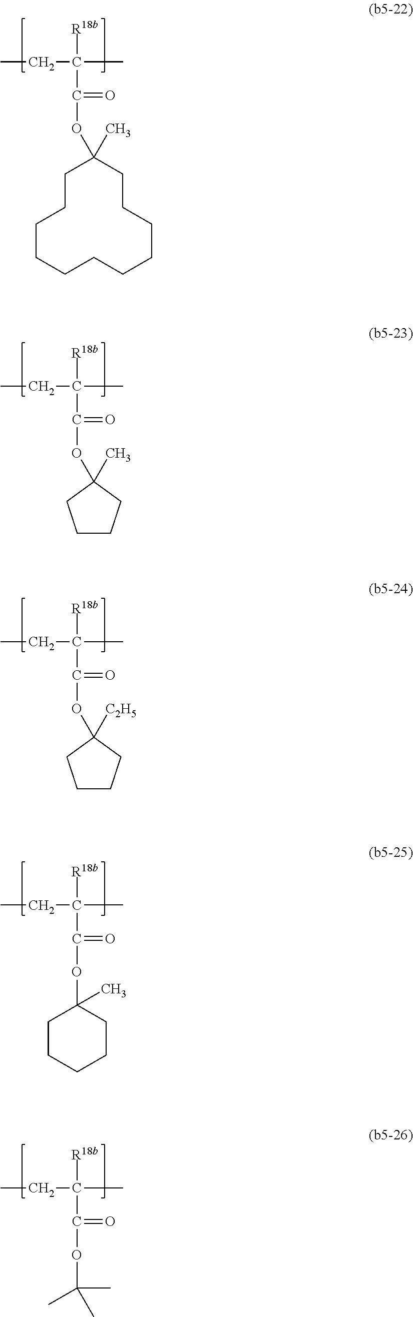

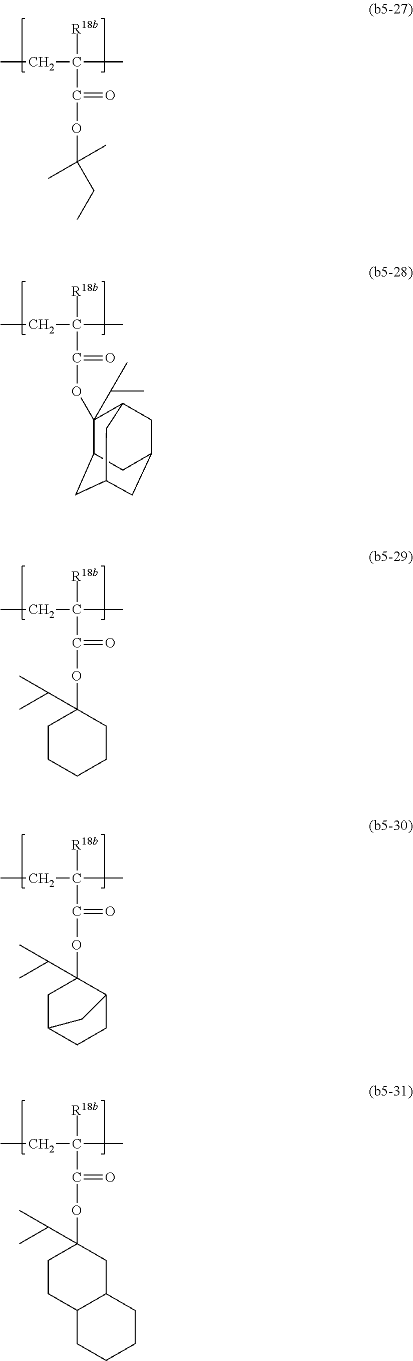

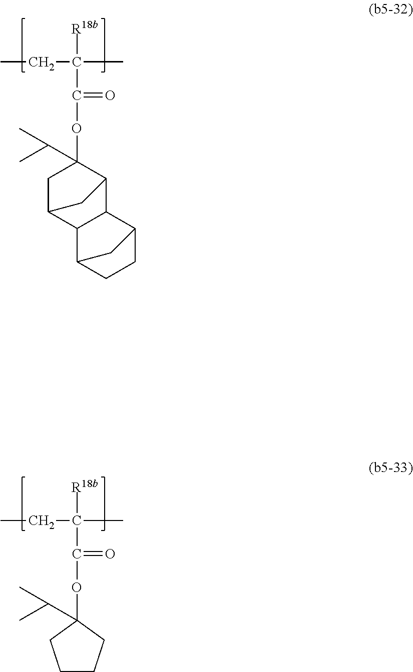

In the formulae (b5-1) to (b5-33), R^{18b} represents a hydrogen atom or a methyl group.

Preferred specific examples of the constituent unit represented by the formula (b6) may include constituent units represented by the following formulae (b6-1) to (b6-24).

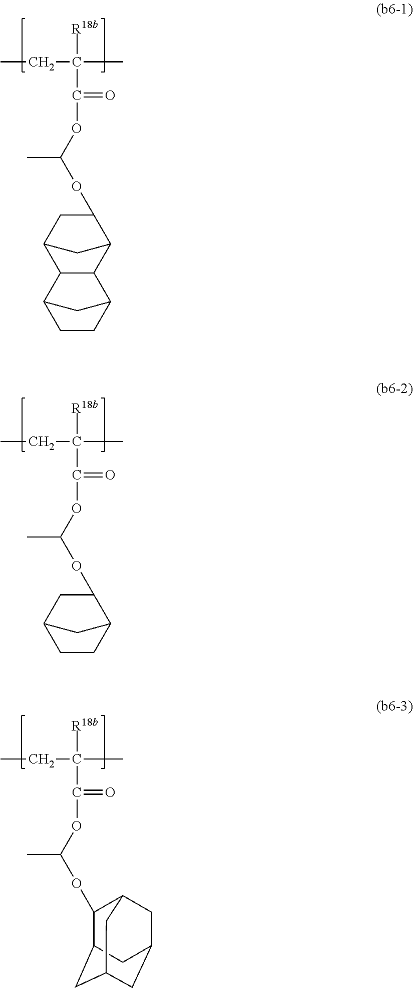

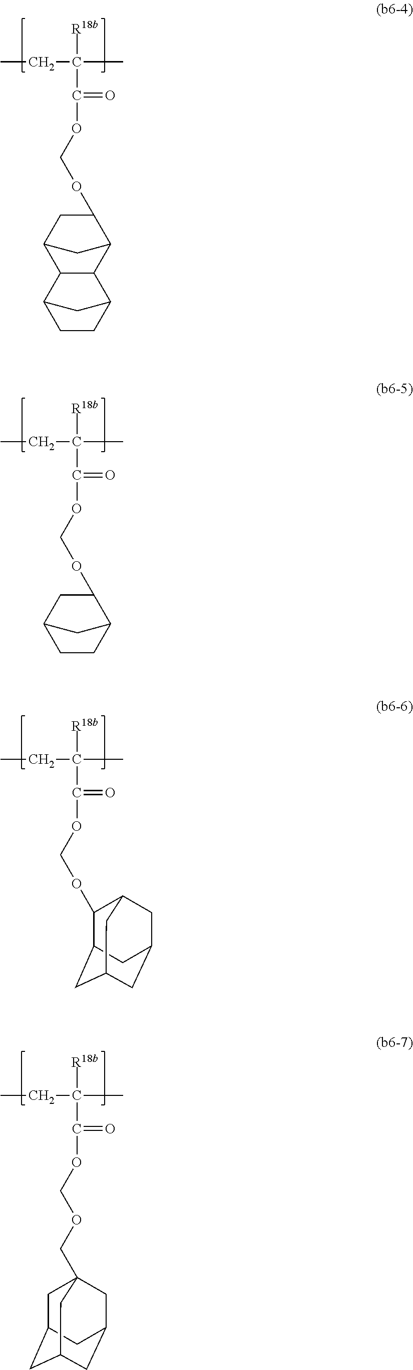

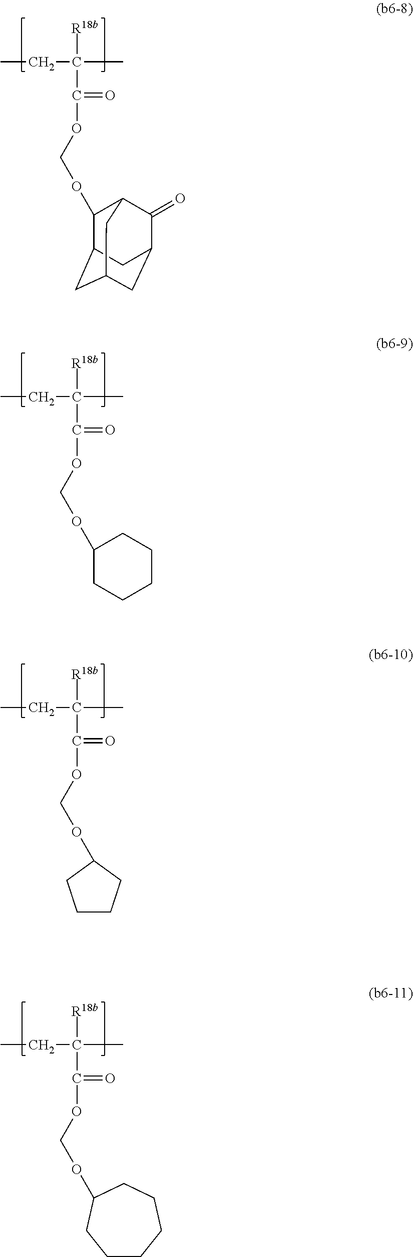

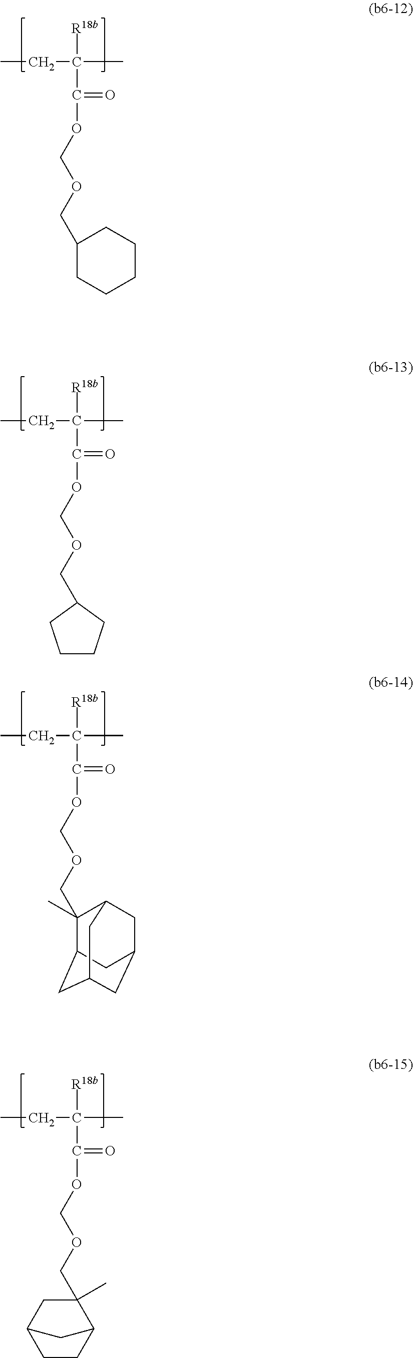

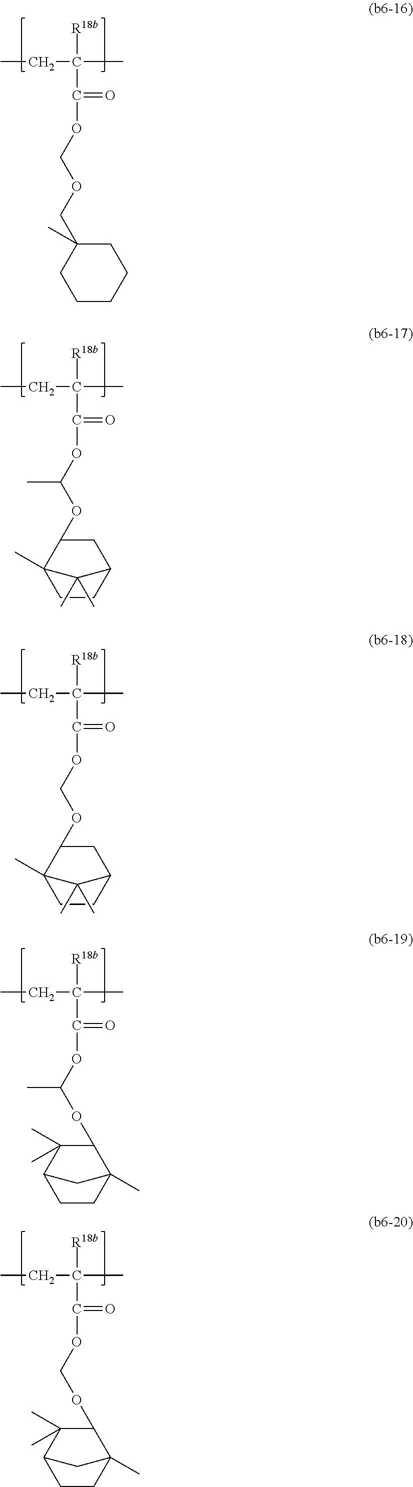

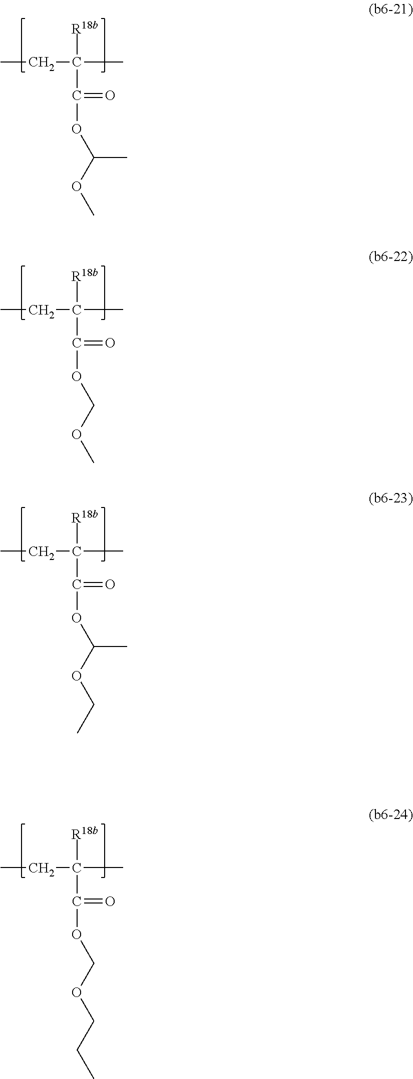

In the formulae (b6-1) to (b624), R^{18b} represents a hydrogen atom or a methyl group.

Preferred specific examples of the constituent unit represented by the formula (b7) may include constituent units represented by the following formulae (b7-1) to (b7-15).

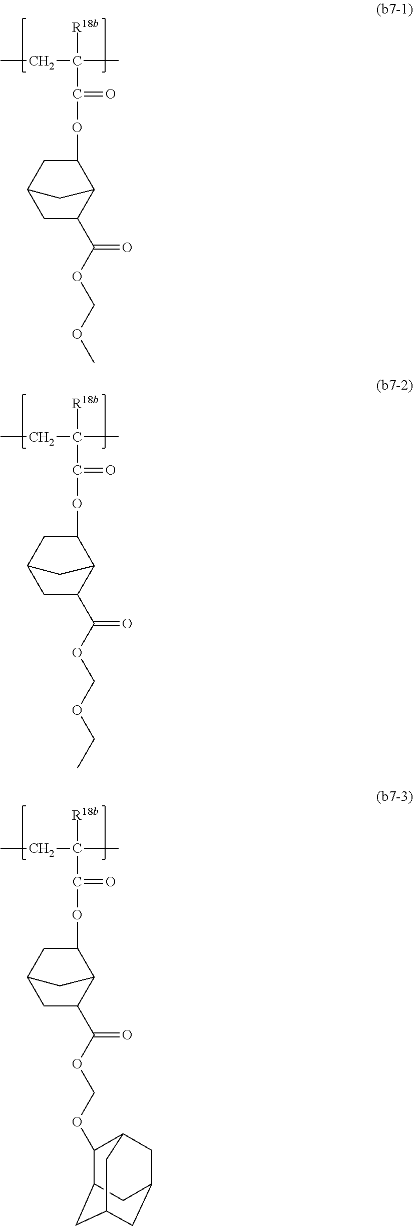

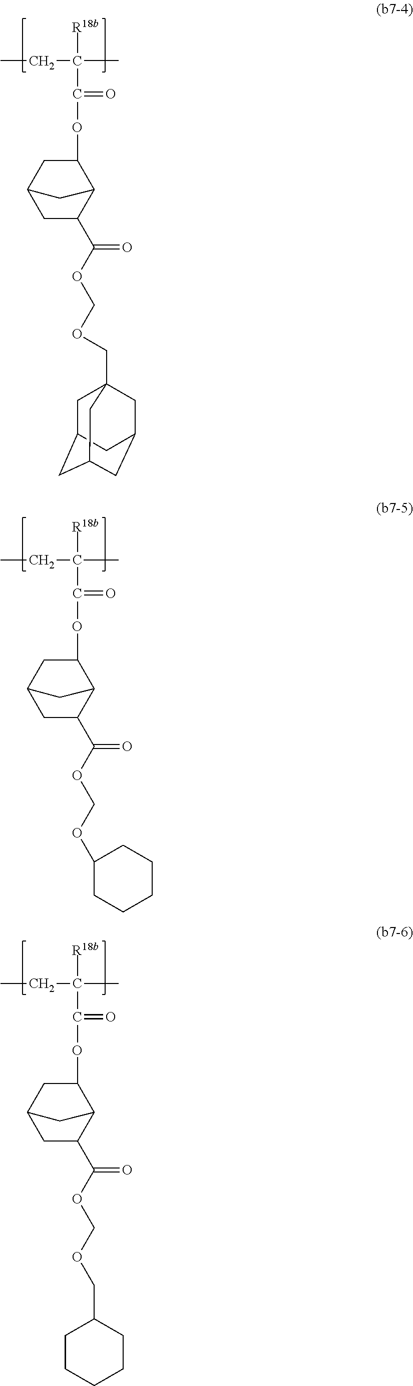

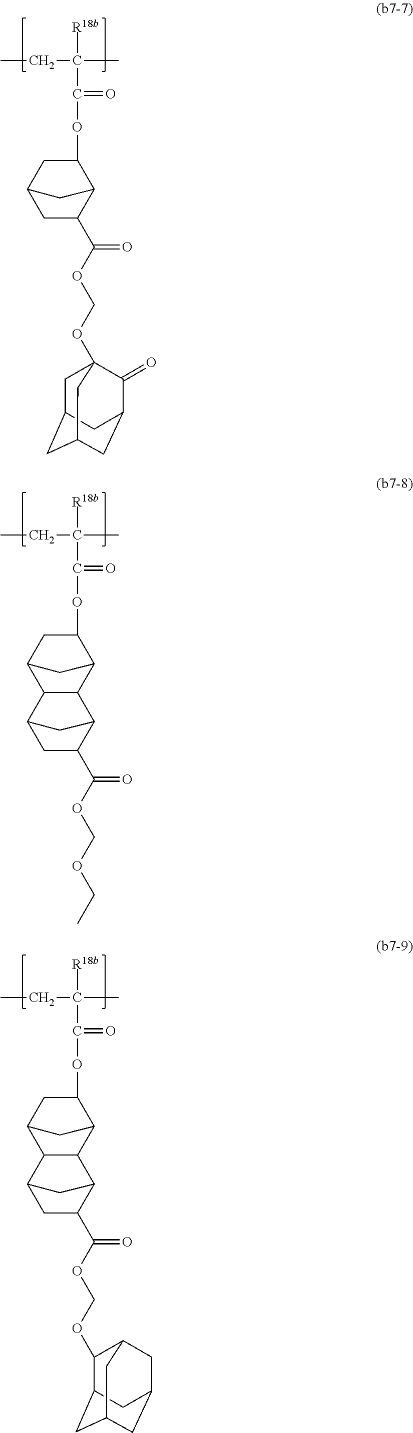

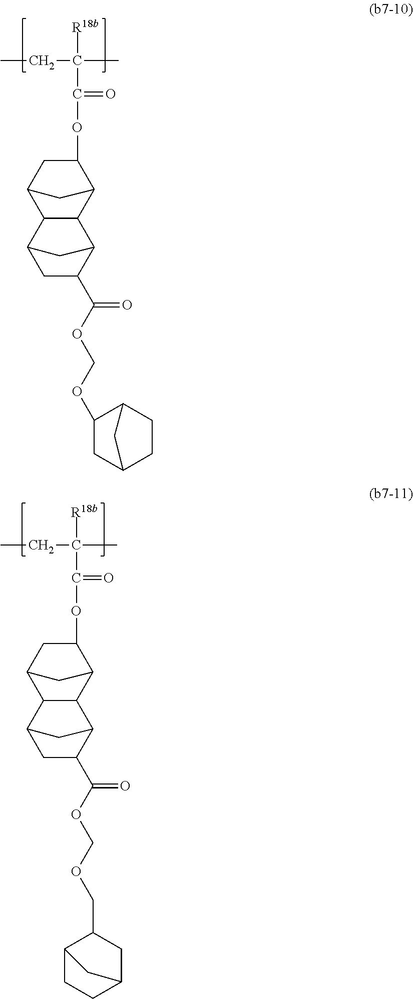

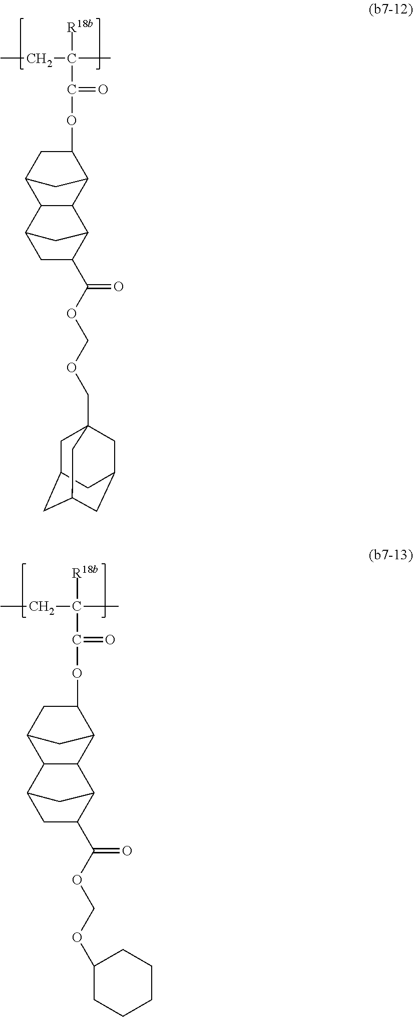

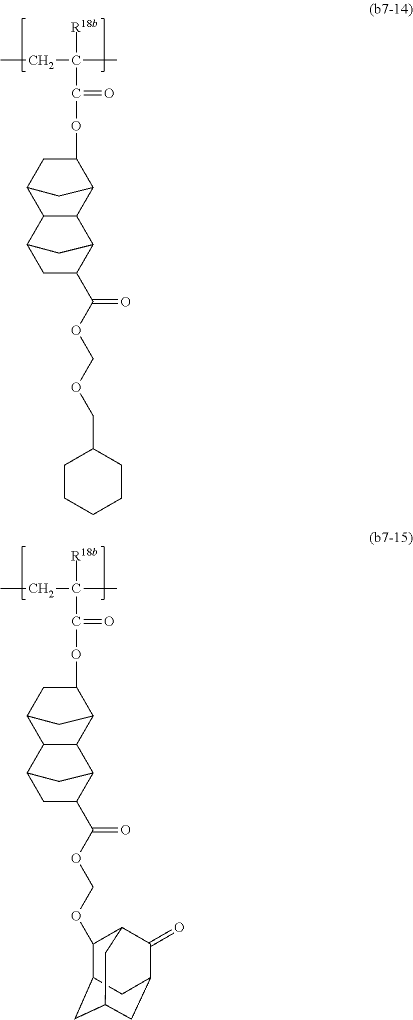

In the formulae (b7-1) to (b7-15), R^{18b} represents a hydrogen atom or a methyl group.

It is preferable that the acrylic resin (B3) is a copolymer containing the constituent units represented by the formulae (b5) to (b7) and a constituent unit derived from a polymerizable compound including an ether bond.

As the polymerizable compound including an ether bond, a radical polymerizable compound such as a (meth)acrylic acid derivative having an ether bond and an ester bond, and specific examples thereof may include 2-methoxyethyl (meth)acrylate, 2-ethoxyethyl (meth)acrylate, methoxytriethylene glycol (meth)acrylate, 3-methoxybutyl (meth)arylate, ethylcarbitol (meth)acylate, phenoxypolyethylene glycol (meth)acrylate, methoxypolyethylene glycol (meth)acrylate, methoxypolypropylene glycol (meth)acrylate, and tetrahydrofurfuryl (meth)acrylate. In addition, the polymerizable compound including an ether bond is preferably 2-methoxyethyl (meth)acrylate, 2-ethoxyethyl (meth)acrylate, or methoxytriethylene glycol (meth)acrylate. The polymerizable compound may be used alone or in combination of two or more kinds thereof.

Further, the acrylic resin (B3) is preferably a copolymer containing a constituent unit selected from the constituent units represented by the formulae (b5) to (b7) and a constituent unit derived from a linear alkyl ester having 3 to 12 carbon atoms of (meth)acrylic acid. When the acrylic resin (B3) contains such a unit, generation of bubbles in a film to be formed is easily suppressed.

Preferred specific examples of the linear alkyl ester having 3 to 12 carbon atoms of (meth)acrylic acid may include n-butyl (meth)acrylate, n-octyl (meth)acrylate, and n-decyl (meth)acrylate.

Further, the acrylic resin (B3) may contain another polymerizable compound as a constituent unit in order to appropriately control physical and chemical characteristics. Examples of such a polymerizable compound may include a conventional radical polymerizable compound or an anionic polymerizable compound.

In addition, examples of such a polymerizable compound may include monocarboxylic acids such as acrylic acid, methacrylic acid, and crotonic acid; dicarboxylic acids such as maleic acid, fumaric acid, and itaconic acid; methacrylic acid derivatives including a carboxyl group and an ester bond such as 2-methacryloyloxyethyl succinic acid, 2-methacryloyloxyethyl maleic acid, 2-methacryloyloxyethyl phthalic acid, or 2-methacryloyloxyethyl hexahydrophthalic acid; (meth)acrylic acid hydroxyalkylesters such as 2-hydroxyethyl (meth)acrylate and 2-hydroxypropyl (meth)acrylate; (meth)acrylic acid esters such as phenyl (meth)acrylate and benzyl (meth)acrylate; dicarboxylic acid diesters such as diethyl maleate and dibutyl fumarate; vinyl group-containing aromatic compounds such as styrene, α-methylstyrene, chlorostyrene, chloromethylstyrene, vinyltoluene, hydroxystyrene, α-methylhydroxystyrene, and α-ethylhydroxystyrene; vinyl group-containing aliphatic compounds such as vinyl acetate; conjugated diolefins such as butadiene and isoprene; nitrile group-containing polymerizable compounds such as acrylonitrile and methacrylonitrile; chlorine-containing polymerizable compounds such as vinyl chloride and vinylidene chloride; and amide bond-containing polymerizable compounds such as acrylamide and methacrylamide.

Examples of the polymerizable compound may include (meth)acrylic acid esters including an acid non-dissociable aliphatic polycyclic group and a vinyl group-containing aromatic compound. As the acid non-dissociable aliphatic polycyclic group, a tricyclodecanyl group, an adamantly group, a tetracyclododecanyl group, an isobonyl group, or a norbornyl group is preferable in terms of industrial availability. These aliphatic polycyclic groups may include a linear or branched alkyl group having 1 to 5 carbon atoms as a substituent.

As the (meth)acrylic acid esters including an acid non-dissociable aliphatic polycyclic group, structures of the following formulae (b8-1) to (b8-5) are specifically exemplified.

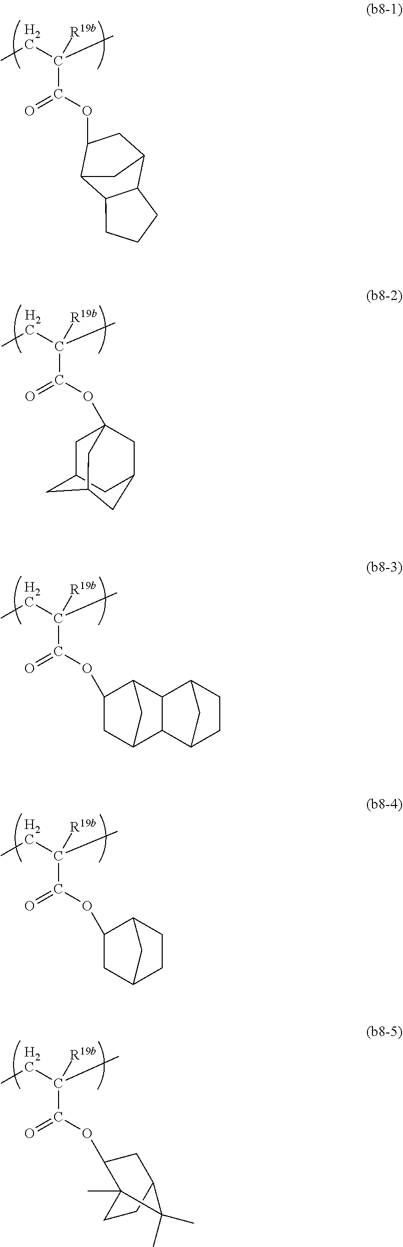

In the formulae (b8-1) to (b8-5), R^{19b} represents a hydrogen atom or a methyl group.

Among the resins (B), the acrylic resin (B3) is preferably used. Among the acrylic resin (B3), a copolymer including a constituent unit represented by the formula (b5), a constituent unit derived from (meth)acrylic acid, a constituent unit derived from (meth)acrylic acid alkylesters, and a constituent unit derived from (meth)acrylic acid arylesters is preferably used.

It is preferable that the composition for forming a film contain a combination of a photoacid generator (C) described below, a resin whose solubility in alkali increases under the action of acid, and an alkali-soluble resin described above. In this case, generation of cracks is easily suppressed after a film to be formed is exposed.

### [Photoacid Generator (C)]

When the resin (B) is a resin whose solubility in alkali increases under the action of acid, the composition for forming a film may contain, together with the resin, the photoacid generator (C) generating acid by irradiation with active rays or radioactive rays. In this way, photosensitivity can be applied to the composition for forming a film.

An acid generator of first to fifth aspects, which will be described below, is preferable as the photoacid generator (C). Hereinafter, with regard to the photoacid generator (C), the preferable one will be described as the first to fifth aspects.

As the first aspect in the photoacid generator (C), the compound represented by the following formula (c1) is exemplified.

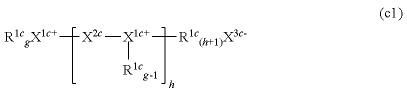

In the formula (c1), X^{1c} represents a sulfur atom or an iodine atom having a valence of g, and g is 1 or 2. h represents the number of repeating units with a structure in parentheses. R^{1c} is an organic group bonded to X^{1c}, and represents an aryl group having 6 to 30 carbon atoms, a heterocyclic group having 4 to 30 carbon atoms, an alkyl group having 1 to 30 carbon atoms, an alkenyl group having 2 to 30 carbon atoms, or an alkynyl group having 2 to 30 carbon atoms, and R^{1c} may be substituted with at least one kind selected from groups consisting of each group of alkyl, hydroxyl, alkoxy, alkylcarbonyl, arylcarbonyl, alkoxycarbonyl, aryloxycarbonyl, arylthiocarbonyl, acyloxy, arylthio, alkylthio, aryl, a heterocyclic ring, aryloxy, alkylsulfinyl, arylsulfinyl, alkylsulfonyl, arylsulfonyl, alkyleneoxy, amino, cyano, and nitro; and halogen. The number of R^{1c}'s is g+h(g−1)+1, and R^{1c}'s may be the same as or different from each other. In addition, two or more R^{1c}'s are bonded to each other directly or via —O—, —S—, —SO—, —SO₂—, —NH—, —NR^{2c}—, —CO—, —COO—, —CONH—, an alkylene group having 1 to 3 carbon atoms, or a phenylene group, and R^{1c}'s may form a ring structure containing X^{1c}. R^{2c} represents an alkyl group having 1 to 5 carbon atoms or an aryl group having 6 to 10 carbon atoms.

X^{2c} is the structure represented by the following formula (c2).

—X^{4c}X^{5c}—X^{4C}ₕ (c2)

In the formula (c2), X^{4c} represents an alkylene group having 1 to 8 carbon atoms, an arylene group having 6 to 20 carbon atoms, or a divalent group of a heterocyclic compound having 8 to 20 carbon atoms, X^{4c} may be substituted with at least one kind selected from groups consisting of each group of alkyl having 1 to 8 carbon atoms, alkoxy having 1 to 8 carbon atoms, aryl having 6 to 10 carbon atoms, hydroxyl, cyano, and nitro; and halogen. X^{5c} represents —O—, —S—, —SO—, —SO₂—, —NH—, —NR^{2c}—, —CO—, —COO—, —CONH—, an alkylene group having 1 to 3 carbon atoms, or a phenylene group. h represents the number of repeating units with a structure in parentheses. (h+1) X^{4c}'s and h X^{5c}'s may be the same as or different from each other. R^{2c} has the same definition as described above.

X^{3c-} is a counter ion of an onium, and examples thereof may include a fluorinated alkyl fluorophosphate anion represented by the following formula (c17) or a borate anion represented by the following formula (c18).

[(R^{3c})ⱼPF₆₋ⱼ]⁻ (c17)

In the formula (c17), R^{3c} represents an alkyl group in which 80% or more of hydrogen atoms are substituted with fluorine atoms. j represents the number thereof and is an integer of 1 to 5. j R^{3c}'s may be the same as or different from each other.

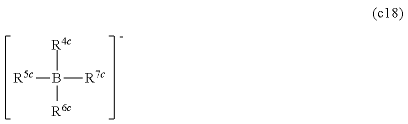

In the formula (c18), R^{4c} to R^{7C} each independently represent a fluorine atom or a phenyl group, and a part or the entireties of hydrogen atoms of the phenyl group may be substituted with at least one kind selected from a group consisting of a fluorine atom and a trifluoromethyl group.

Examples of the onium ion in the compound represented by the formula (c1) include triphenyl sulfonium, tri-p-tolyl sulfonium, 4-(phenylthio)phenyldiphenyl sulfonium, bis[4-(diphenylsulfonio)phenyl]sulfide, bis[4-{bis[4-(2-hydroxyethoxy)phenyl]sulfonio}phenyl]sulfide, bis{4-[bis(4-fluorophenyl)sulfonio]phenyl}sulfide, 4-(4-benzoyl-2-chlorophenylthio)phenylbis(4-fluorophenyl)sulfonium, 7-isopropyl-9-oxo-10-thia-9,10-dihydro anthracene-2-yldi-p-tolyl sulfonium, 7-isopropyl-9-oxo-10-thia-9,10-dihydro anthracene-2-yldiphenyl sulfonium, 2-[(diphenyl) sulfonio]thioxanthone, 4-[4-(4-tert-butylbenzoyl)phenylthio]phenyldi-p-tolyl sulfonium, 4-[4-(benzoylphenylthio)]phenyldiphenyl sulfonium, diphenylphenacyl sulfonium, 4-hydroxyphenylmethylbenzyl sulfonium, 2-naphthylmethyl (1-ethoxy carbonyl) ethyl sulfonium, 4-hydroxyphenylmethylphenacyl sulfonium, phenyl[4-(4-biphenylthio)phenyl]4-biphenyl sulfonium, phenyl[4-(4-biphenylthio)phenyl]3-biphenyl sulfonium, [4-(4-acetophenylthio)phenyl]diphenyl sulfonium, octadecylmethylphenacyl sulfonium, diphenyl iodonium, di-p-tolyliodonium, bis(4-dodecylphenyll)iodonium, bis(4-methoxyphenyl)iodonium, (4-octyloxyphenyl)phenyliodonium, bis(4-decyloxy)phenyliodonium, 4-(2-hydroxytetradecyloxy)phenylphenyliodonium, 4-isopropylphenyl(p-tolyl)iodonium, and 4-isobutylphenyl(p-tolyl)iodonium.

As the preferable onium ion among onium ions in the compound represented by the formula (c1), a sulfonium ion represented by the following formula (c19) is exemplified.

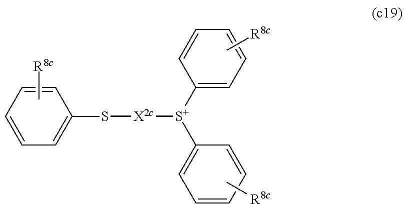

In the formula (c19), R^{8c}'s each independently represent groups selected from a group consisting of a hydrogen atom, alkyl, hydroxyl, alkoxy, alkylcarbonyl, alkylcarbonyloxy, alkyloxycarbonyl, a halogen atom, aryl which may have a substituent, and arylcarbonyl. X^{2c} has the same definition as that of X^{2c} in the formula (c1).

Specific examples of the sulfonium ion represented by the formula (c19) may include 4-(phenylthio)phenyldiphenyl sulfonium, 4-(4-benzoyl-2-chlorophenylthio)phenylbis(4-fluorophenyl)sulfonium, 4-(4-benzoylphenylthio)phenyldiphenyl sulfonium, phenyl[4-(4-biphenylthio)phenyl]4-biphenyl sulfonium, phenyl[4-(4-biphenylthio)phenyl]3-biphenyl sulfonium, [4-(4-acetophenylthio)phenyl]diphenyl sulfonium, and diphenyl[4-(p-terphenylthio)phenyl]diphenyl sulfonium.

In the fluorinated alkyl fluorophosphate anion represented by the formula (c17), R^{3c} represents an alkyl group substituted with a fluorine atom, and the number of carbon atoms is preferably 1 to 8 and more preferably 1 to 4. Specific example of the alkyl group may include a linear alkyl group such as methyl, ethyl, propyl, butyl, pentyl, or octyl; a branched alkyl group such as isopropyl, isobutyl, sec-butyl, or tert-butyl; and a cycloalkyl group such as cyclopropyl, cyclobutyl, cyclopentyl, or cyclohexyl. The ratio of a hydrogen atom in the alkyl group which is substituted with a fluorine atom is generally 80% or more, preferably 90% or more, and still more preferably 100%. In a case in which the substitution ratio of the fluorine atom is less than 80%, the acid strength of the onium fluorinated alkyl fluorophosphate represented by the formula (c1) decreases.

R^{3c} is particularly preferably a linear or branched perfluoroalkyl group having 1 to 4 carbon atoms and the substitution ratio of a fluorine atom is 100%, and specific examples thereof may include CF₃, CF₃CF₂, (CF₃)₂CF, CF₃CF₂CF₂, CF₃CF₂CF₂CF₂, (CF₃)₂CFCF₂, CF₃CF₂(CF₃)CF, and (CF₃)₃C. j which is the number of R^{3c}'s is an integer of 1 to 5, preferably 2 to 4, and particularly preferably 2 or 3.

Preferable specific examples of the fluorinated alkyl fluorophosphate anion may include [(CF₃CF₂)₂PF₄]⁻, [(CF₃CF₂)₃PF₃]⁻, [((CF₃)₂CF)₂PF₄]⁻, [((CF₃)₂CF)₃PF₃]⁻, [(CF₃CF₂CF₂)₂PF₄]⁻, [(CF₃CF₂CF₂)₃PF₃]⁻, [((CF₃)₂CFCF₂)₂PF₄]⁻, [((CF₃)₂CFCF₂)₃PF₃]⁻, [(CF₃CF₂CF₂CF₂)₂PF₄]⁻, and [(CF₃CF₂CF₂)₃PF₃]—, and among these, [(CF₃CF₂)₃PF₃]⁻, [(CF₃CF₂CF₂)₃PF₃]⁻, [((CF₃)₂CF)₃PF₃]⁻, [((CF₃)₂CF)₂PF₄]⁻, [((CF₃)₂CFCF₂)₃PF₃]⁻ or [((CF₃)₂CFCF₂)₂PF₄]⁻ is particularly preferable.

Preferable specific examples of the borate anion represented by the formula (c18) may include tetrakis(pentafluorophenyl)borate ([B(C₆F₅)₄]⁻), tetrakis[(trifluoromethyl)phenyl]borate ([B(C₆H₄CF₃)₄]⁻), difluorobis(pentafluorophenyl)borate ([(C₆F₅)₂BF₂]⁻), trifluoro(pentafluorophenyl)borate ([(C₆F₅)BF₃]⁻), and tetrakis(difluorophenyl)borate ([B(C₆H₃F₂)₄]⁻). Among these, tetrakis(pentafluorophenyl)borate ([B(C₆F₅)₄]⁻) is particularly preferable.

As the second aspect, examples of the photoacid generator (C) may include a halogen-containing triazine compound such as 2,4-bis(trichloromethyl)-6-piperonyl-1,3,5-triazine, 2,4-bis(trichloromethyl)-6-[2-(2-furyl)ethenyl]-s-triazine, 2,4-bis(trichloromethyl)-6-[2-(5-methyl-2-furyl)ethenyl]-s-triazine, 2,4-bis(trichloromethyl)-6-[2-(5-ethyl-2-furyl)ethenyl]-s-triazine, 2,4-bis(trichloromethyl)-6-[2-(5-propyl-2-furyl)ethenyl]-s-triazine, 2,4-bis(trichloromethyl)-6-[2-(3,5-dimethoxyphenyl)ethenyl]-s-triazine, 2,4-bis(trichloromethyl)-6-[2-(3,5-diethoxyphenyl)ethenyl]-s-triazine, 2,4-bis(trichloromethyl)-6-[2-(3,5-dipropoxyphenyl)ethenyl]-s-triazine, 2,4-bis(trichloromethyl)-6-[2-(3-methoxy-5-ethoxyphenyl)ethenyl]-s-triazine, 2,4-bis(trichloromethyl)-6-[2-(3-methoxy-5-propoxyphenyl)ethenyl]-s-triazine, 2,4-bis(trichloromethyl)-6-[2-(3,4-methylenedioxyphenyl)ethenyl]-s-triazine, 2,4-bis(trichloromethyl)-6-(3,4-methylenedioxyphenyl)-s-triazine, 2,4-bis-trichloromethyl-6-(3-bromo-4-methoxy)phenyl-s-triazine, 2,4-bis-trichloromethyl-6-(2-bromo-4-methoxy)phenyl-s-triazine, 2,4-bis-trichloromethyl-6-(2-bromo-4-methoxy)styrylphenyl-s-triazine, 2,4-bis-trichloromethyl-6-(3-bromo-4-methoxy)styrylphenyl-s-triazine, 2-(4-methoxyphenyl)-4,6-bis(trichloromethyl)-1,3,5-triazine, 2-(4-methoxynaphthyl)-4,6-bis(trichloromethyl)-1,3,5-triazine, 2-[2-(2-furyl)ethenyl]-4,6-bis(trichloromethyl)-1,3,5-triazine, 2-[2-(5-methyl-2-furyl)ethenyl]-4,6-bis(trichloromethyl)-1,3,5-triazine, 2-[2-(3,5-dimethoxyphenyl)ethenyl]-4,6-bis(trichloromethyl)-1,3,5-triazine, 2-[2-(3,4-dimethoxyphenyl)ethenyl]-4,6-bis(trichloromethyl)-1,3,5-triazine, 2-(3,4-methylenedioxyphenyl)-4,6-bis(trichloromethyl)-1,3,5-triazine, tris(1,3-dibromopropyl)-1,3,5-triazine, or tris(2,3-dibromopropyl)-1,3,5-triazine; and a halogen-containing triazine compound represented by the formula (c3) such as tris(2,3-dibromopropyl)isocyanurate.

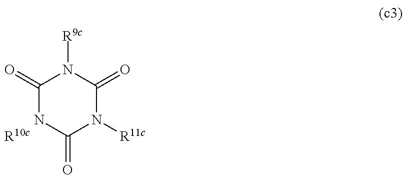

In the formula (c3), R^{9c}, R^{10c}, and R^{11c} each independently represent a halogenated alkyl group.

Further, as the third aspect, examples of the photoacid generator (C) may include α-(p-toluenesulfonyloxyimino)phenylacetonitrile, α-(benzenesulfonyloxyimino)-2,4-dichlorophenylacetonitrile, α-(benzenesulfonyloxyimino)-2,6-dichlorophenylacetonitrile, α-(2-chlorobenzenesulfonyloxyimino)-4-methoxyphenylacetonitrile, α-(ethylsulfonyloxyimino)-1-cyclopentenylacetonitrile, and a compound represented by the formula (c4), which contains an oxime sulfonate group.

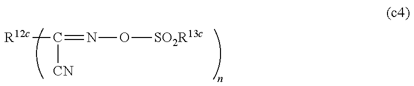

In the formula (c4), R^{12c} represents a monovalent, divalent, or trivalent organic group, R^{13c} represents substituted or unsubstituted saturated hydrocarbon, unsaturated hydrocarbon, or an aromatic compound group, and n represents the number of repeating units with a structure in parentheses.

In the formula (c4), the aromatic compound group is a group of a compound showing physical and chemical properties peculiar to an aromatic compound, and examples thereof may include an aryl group such as a phenyl group or a naphthyl group; and a heteroaryl group such as a furyl group or a thienyl group. These may include one or more appropriate substituents such as a halogen atom, an alkyl group, an alkoxy group, and a nitro group on a ring. Further, R^{13c} is particularly preferably an alkyl group having 1 to 6 carbon atoms, and examples thereof may include a methyl group, an ethyl group, a propyl group, or a butyl group. Particularly, a compound in which R^{12c} is an aromatic compound group and R^{13c} is an alkyl group having 1 to 4 carbon atoms is preferable.

As the photoacid generator represented by the formula (c4), when n is 1, R^{12c} is any one of a phenyl group, a methylphenyl group, and a methoxyphenyl group, and R^{13c} is a compound of a methyl group, and specific examples thereof may include α-(methylsulfonyloxyimino)-1-phenylacetonitrile, α-(methylsulfonyloxyimino)-1-(p-methylphenyl)acetonitrile, α-(methylsulfonyloxyimino)-1-(p-methoxyphenyl)acetonitrile, and [2-(propylsulfonyloxyimino)-2,3-dihydroxythiophene-3-ylidene](o-tolyl)acetonitrile. When n is 2, as the photoacid generator represented by the formula (c4), a photoacid generator represented by the following formula is specifically exemplified.

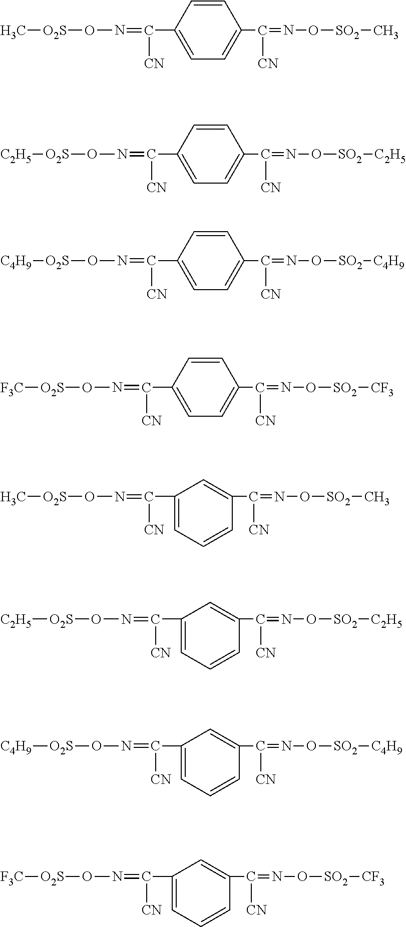

Further, as the fourth aspect in the photoacid generator (C), an onium salt having a naphthalene ring in a cationic moiety is exemplified. The expression “having a naphthalene ring” means that a structure derived from naphthalene is included and a structure with at least two rings and the aromaticity thereof are maintained. The naphthalene ring may include a substituent such as a linear or branched alkyl group having 1 to 6 carbon atoms, a hydroxyl group, or a linear or branched alkoxy group having 1 to 6 carbon atoms. The structure derived from the naphthalene ring may be monovalent (residual valence is one) or divalent (residual valence is two) or higher valent, but monovalent is desired (provided that, at this time, the residual valence is counted exclusive of the portion bonded to the substituent). The number of the naphthalene rings is preferably 1 to 3.

As the cationic moiety of the onium salt including naphthalene rings in the cationic moiety, the structure represented by the following formula (c5) is preferable.

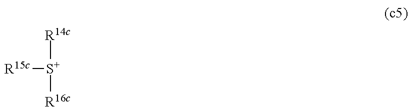

In the formula (c5), at least one of R^{14c}, R^{15c}, and R^{16c} represents a group represented by the following formula (c6), and the rest represents a linear or branched alkyl group having 1 to 6 carbon atoms, a phenyl group which may have a substituent, a hydroxyl group, or a linear or branched alkoxy group having 1 to 6 carbon atoms. Alternatively, one of R^{14c}, R^{15c}, and R^{16c} represents a group represented by the following formula (c6), and the rest two each independently represent a linear or branched alkylene group having 1 to 6 carbon atoms, and the terminals thereof may be bonded to each other to have a cyclic form.

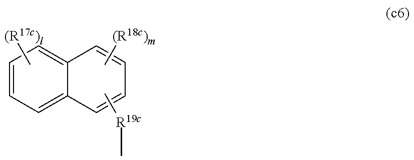

In the formula (c6), R^{17c} and R^{18c} each independently represent a hydroxyl group, a linear or branched alkoxy group having 1 to 6 carbon atoms, or a linear or branched alkyl group having 1 to 6 carbon atoms, and R^{19c} represents a single bond or a linear or branched alkylene group having 1 to 6 carbon atoms which may include a substituent. l and m each independently represent an integer of 0 to 2 and 1+m is 3 or less. Provided that, when a plurality of R^{17c}'s are present, these may be the same as or different from each other. In addition, when a plurality of R^{18c}'s are present, these may be the same as or different from each other.

The number of groups represented by the formula (c6) among R^{14c}, R^{15c}, and R^{16c} is preferably 1 in terms of stability of a compound, and the rest are linear or branched alkylene groups having 1 to 6 carbon atoms, and terminals thereof may be bonded to each other to have a cyclic form. In this case, the two alkylene groups may constitute a 3- to 9-membered ring including a sulfur atom. The number of atoms (including sulfur atoms) constituting a ring is preferably 5 or 6.

Further, as the substituent which may be included in the alkylene group, an oxygen atom (in this case, a carbonyl group is formed together with a carbon atom constituting the alkylene group) or a hydroxyl group is exemplified.

Furthermore, as the substituent which may be included in the phenyl group, a hydroxyl group, a linear or branched alkoxy group having 1 to 6 carbon atoms, or a linear or branched alkyl group having 1 to 6 carbon atoms is exemplified.

Preferred examples of the cationic moiety may include the structures represented by the following formulae (c7) and (c8), and the structure represented by the following formula (c8) is particularly preferable.

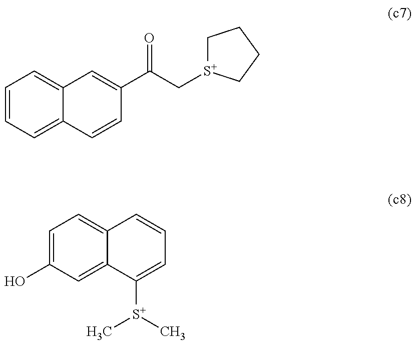 [SMILES: O=C(C[S+]1CCCC1)c1ccc2ccccc2c1 ; C[S+](C)c1cccc2ccc(O)cc12]

Such a cationic moiety may be an iodonium salt or a sulfonium salt, but a sulfonium salt is desired in terms of acid generating efficiency or the like.

Accordingly, as a preferred example of an anionic moiety of an onium salt having a naphthalene ring in a cationic moiety, an anion which can form a sulfonium salt is desired.

As the anionic moiety of such an acid generator, a fluoroalkylsulfonic acid ion in which a part or the entireties of hydrogen atoms are fluorinated or an arylsulfonic acid ion may be used.

The alkyl group in the fluoroalkylsulfonic acid ion may be a linear, branched, or cyclic group having 1 to 20 carbon atoms, and the number of carbon atoms is preferably 1 to 10 from a viewpoint of bulkiness of an acid to be generated and the diffusion distance thereof. Particularly, a branched or cyclic group is preferable because the diffusion distance is short. Further, as preferred examples thereof, a methyl group, an ethyl group, a propyl group, a butyl group, and an octyl group are preferable because they can be synthesized at a low cost.

The aryl group in the arylsulfonic acid ion is an aryl group having 6 to 20 carbon atoms, and examples thereof may include an alkyl group, a phenyl group which may or may not be substituted with a halogen atom, or a naphthyl group. Particularly, an aryl group having 6 to 10 carbon atoms is preferable because synthesis is possible at a low cost. Preferred specific examples thereof may include a phenyl group, a toluenesulfonyl group, an ethylphenyl group, a naphthyl group, and a methylnaphthyl group.

In regard to the fluoroalkylsulfonic acid ion or the arylsulfonic acid ion, when a part or the entireties of hydrogen atoms are fluorinated, the fluorination ratio thereof is preferably 10% to 100% and more preferably 50% to 100%. Particularly, the one in which the entireties of hydrogen atoms are substituted with fluorine atoms is preferable because the strength of an acid becomes strong. Specific examples thereof may include trifluoromethanesulfonate, perfluorobutanesulfonate, perfluorooctanesulfonate, and perfluorobenzenesulfonate.

Among these, as the preferable anionic moiety, the structure represented by the following formula (c9) is exemplified.

R^{20c}SO₂ (c9)

In the formula (c9), R^{20c} is a group represented by the following formulae (c10) and (c11) or a group represented by the following formula (c12).

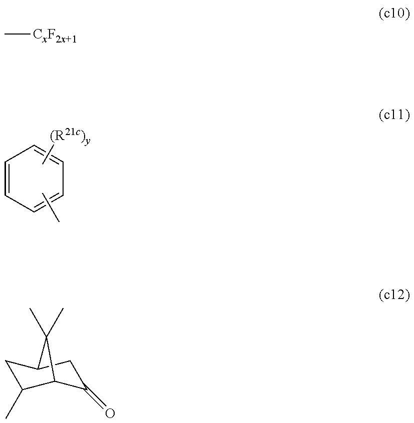

In the formula (c10), x represents an integer of 1 to 4. In addition, in the formula (c11), R^{21c} represents a hydrogen atom, a hydroxyl group, a linear or branched alkyl group having 1 to 6 carbon atoms, or a linear or branched alkoxy group having 1 to 6 carbon atoms, and y represents an integer of 1 to 3. Among these, trifluoromethanesulfonate or perfluorobutanesulfonate is preferable from a viewpoint of safety.

Further, as the anionic moiety, a structure containing nitrogen represented by the following formulae (c13) and (c14) can be used.

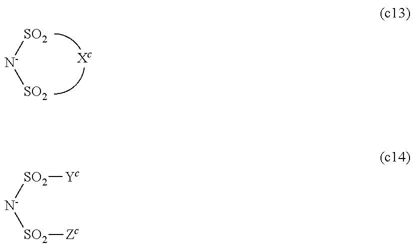

In the formulae (c13) and (c14), X^{c} represents a linear or branched alkylene group in which at least one hydrogen atom is substituted with a fluorine atom, and the number of carbon atoms of the alkylene group is 2 to 6, preferably 3 to 5, and most preferably 3. In addition, Y^{c} and Z^{c} each independently represent a linear or branched alkyl group in which at least one of hydrogen atoms is substituted with a fluorine atom, and the number of carbon atoms of the alkyl group is 1 to 10, preferably 1 to 7, and more preferably 1 to 3.

As the number of carbon atoms of the alkylene group of X^{c} or the number of carbon atoms of the alkyl group of Y^{c} and Z^{c} become smaller, the solubility in an organic solvent becomes more excellent, which is preferable.

Moreover, in the alkylene group of X^{c} or the alkyl group of Y^{c} or Z^{c}, as the number of hydrogen atoms substituted with fluorine atoms becomes larger, the strength of acid becomes stronger, which is preferable. The ratio of fluorine atoms in the alkylene group or the alkyl group, that is, the fluorination ratio is preferably 70% to 100% and more preferably 90% to 100%, and a perfluoroalkylene group or a perfluoroalkyl group in which the entireties of hydrogen atoms are substituted with fluorine atoms is most preferable.

As the onium salt having a naphthalene ring in the cationic moiety, the compounds represented by the following formulae (c15) and (c16) are preferably exemplified.

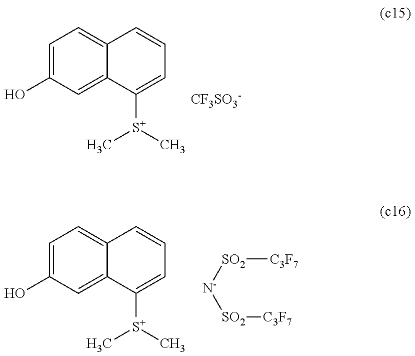

In addition, as the fifth aspect, examples of the photoacid generator (C) may include bissulfonyldiazomethanes such as bis(p-toluenesulfonyl)diazomethane, bis(1,1-dimethylethylsulfonyl)diazomethane, bis(cyclohexylsulfonyl)diazomethane, and bis(2,4-dimethylphenylsulfonyl)diazomethane; nitrobenzyl derivatives such as p-toluenesulfonic acid 2-nitrobenzyl, p-toluenesulfonic acid 2,6-dinitrobenzyl, nitrobenzyltosylate, dinitrobenzyltosylate, nitrobenzylsulfonate, nitrobenzylcarbonate, and dinitrobenzylcarbonate; sulfonic acid esters such as pyrogalloltrimesylate, pyrogalloltritosylate, benzyltosylate, benzylsulfonate, N-methylsulfonyloxysuccinimide, N-trichloromethylsulfonyloxysuccinimide, N-phenylsulfonyloxymaleimide, and N-methylsulfonyloxyphthalimide; trifluoromethanesulfonic acid esters such as N-hydroxyphthalimide, and N-hydroxynaphthalimide; onium salts such as diphenyliodoniumhexafluorophosphate, (4-methoxyphenyl)phenyliodoniumtrifluoromethanesulfonate, bis(p-tert-butylphenyl)iodoniumtrifluoromethanesulfonate, triphenylsulfoniumhexafluorophosphate, (4-methoxyphenyl)diphenylsulfoniumtrifluoromethanesulfonate, and (p-tert-butylphenyl)diphenylsulfoniumtrifluoromethanesulfonate; benzointosylates such as benzointosylate and α-methylbenzointosylate; other diphenyliodonium salts; triphenylsulfonium salts; phenyldiazonium salts; and benzylcarbonate.

The content of the photoacid generator (C) in the composition for forming a film is not particularly limited to the extent that the object of the present invention is not prevented from being attained. The content of the photoacid generator (C) in the composition for forming a film is preferably 0.1% by mass to 10% by mass and more preferably 0.5% by mass to 3% by mass based on the entire mass of the composition for forming a film.

### [Acid Diffusion Control Agent (D)]

When the composition for forming a film contains the resin whose solubility in alkali increases under the action of acid and the photoacid generator (C), it is preferable that the composition for forming a film further contain an acid diffusion control agent (D) from a viewpoint of improvement of shape and post-exposure delay stability of the pattern formed using the composition for forming a film. As the acid diffusion control agent (D), a nitrogen-containing compound (D1) is preferable and organic carboxylic acid, phosphorous oxo acid, or the derivative (D2) thereof can be contained therein if necessary.

### (Nitrogen-Containing Compound (D1))

Examples of the nitrogen-containing compound (D1) may include trimethylamine, diethylamine, triethylamine, di-n-propylamine, tri-n-propylamine, tri-n-pentylamine, tribenzylamine, diethanolamine, triethanolamine, n-hexylamine, n-heptylamine, n-octylamine, n-nonylamine, ethylenediamine, N,N,N′,N′-tetramethylethylenediamine, tetramethylenediamine, hexamethylenediamine, 4,4′-diaminodiphenylmethane, 4,4′-diaminodiphenylether, 4,4′-diaminobenzophenone, 4,4′-diaminodiphenylamine, formamide, N-methylformamide, N,N-dimethylformamide, acetamide, N-methylacetamide, N,N-dimethylacetamide, propionamide, benzamide, pyrrolidone, N-methylpyrrolidone, methylurea, 1,1-dimethylurea, 1,3-dimethylurea, 1,1,3,3,-tetramethylurea, 1,3-diphenylurea, imidazole, benzimidazole, 4-methylimidazole, 8-oxyquinoline, acridine, purine, pyrrolidine, piperidine, 2,4,6-tri(2-pyridyl)-S-triazine, morpholine, 4-methylmorpholine, piperazine, 1,4-dimethylpiperazine, 1,4-diazabicyclo[2,2,2]octane, and pyridine. These may be used alone or in combination of two or more kinds thereof.

The nitrogen-containing compound (D1) is generally used in the range of 0 part by mass to 5 parts by mass based on 100 parts by mass of the resin (B) and particularly preferably used in the range of 0 part by mass to 3 parts by mass.

### (Organic Carboxylic Acid, Phosphorous Oxo Acid, or Derivative Thereof (D2))

Among the organic carboxylic acid, the phosphorous oxo acid, or the derivative thereof (D2), preferred specific examples of the organic carboxylic acid may include malonic acid, citric acid, malic acid, succinic acid, benzoic acid, and salicylic acid, and salicylic acid is particularly preferable.

Examples of the phosphorous oxo acid or the derivative thereof may include phosphoric acid and the derivatives thereof such as their esters such as phosphoric acid di-n-butyl ester, or phosphoric acid diphenyl ester; phosphonic acid and the derivatives thereof such as their esters such as phosphonic acid dimethyl ester, phosphonic acid-di-n-butyl ester, phenylphosphonic acid, phosphonic acid diphenyl ester, or phosphonic acid dibenzyl ester; and phosphinic acid such as phosphinic acid or phenylphosphinic acid and the derivatives thereof such as their esters. Among these, phosphonic acid is particularly preferable. These may be used alone or in combination of two or more kinds thereof.

The organic carboxylic acid, the phosphorous oxo acid, or the derivative thereof (D2) is generally used in the range of 0 part by mass to 5 parts by mass based on 100 parts by mass of the resin (B) and particularly preferably used in the range of 0 part by mass to 3 parts by mass.

It is preferable that the amount of the organic carboxylic acid, the phosphorous oxo acid, or the derivative thereof (D2) to be used be the same as that of the nitrogen-containing compound (D1) in order for salts to be formed and stabilized.

### [Other Components]

The composition for forming a film may further contain a polyvinyl resin for improving plasticity of the film to be formed. Specific examples of the polyvinyl resin may include polyvinyl chloride, polystyrene, polyhydroxystyrene, polyvinyl acetate, polyvinyl benzoate, polyvinylmethylether, polyvinylethylether, polyvinylalcohol, polyvinylpyrrolidone, polyvinylphenol, and the copolymer thereof. The polyvinyl resin is preferably polyvinylmethylether in terms of a low glass transition point.

The composition for forming a film may further contain an adhesive aid for improving adhesive properties with a support.

The composition for forming a film may further contain a surfactant for improving coating properties, defoaming properties, and levelling properties. Specific examples of the surfactant may include commercially available fluorine-based surfactants such as BM-1000, BM-1100 (both manufactured by BM Chemistry Co., Ltd.), MEGAFAC F142D, MEGAFAC F172, MEGAFAC F173, MEGAFAC F183 (all manufactured by DIC Corporation), FLUORAD FC-135, FLUORAD FC170C, FLUORAD FC-430, FLUORAD FC-431 (all manufactured by Sumitomo 3M Ltd.), SURFLON S-112, SURFLON S-113, SURFLON S-131, SURFLON S-141, SURFLON S-145 (all manufactured by Asahi Glass Co., Ltd.), SH-28PA, SH-190, SH-193, and SZ-6032, SF-8428 (all manufactured by Dow Corning Toray Silicone Co., Ltd.), but the surfactants are not limited thereto.

When the composition for forming a film contains a resin whose solubility in alkali increases under the action of acid and a photoacid generator, the composition for forming a film may further contain acid or acid anhydride in order to perform fine adjustment of the solubility in a developer solution of the composition for forming a film.

Specific examples of the acid and the acid anhydride may include monocarboxylic acids such as acetic acid, propionic acid, n-butyric acid, isobutyric acid, n-valeric acid, isovaleric acid, benzoic acid, and cinnamic acid; hydroxymonocarboxylic acids such as lactic acid, 2-hydroxybutyric acid, 3-hydroxybutyric acid, salicylic acid, m-hydroxybenzoic acid, p-hydroxybenzoic acid, 2-hydroxycinnamic acid, 3-hydroxycinnamic acid, 4-hydroxycinnamic acid, 5-hydroxyisophthalic acid, and syringic acid; polyvalent carboxylic acids such as oxalic acid, succinic acid, glutaric acid, adipic acid, maleic acid, itaconic acid, hexahydrophthalic acid, phthalic acid, isophthalic acid, terephthalic acid, 1,2-cyclohexanedicarboxylic acid, 1,2,4-cyclohexanetricarboxylic acid, butanetetracarboxylic acid, trimellitic acid, pyromellitic acid, cyclopentanetetracarboxylic acid, butanetetracarboxylic acid, and 1,2,5,8-naphthalenetetracarboxylic acid; acid anhydride such as itaconic acid anhydride, succinic anhydride, citraconic anhydride, dodecenylsuccinic anhydride, tricarbanilic anhydride, maleic anhydride, hexahydrophthalic anhydride, methyltetrahydrophthalic anhydride, himic anhydride, 1,2,3,4-butanetetracarboxylic anhydride, cyclopentanetetracarboxylic dianhydride, phthalic anhydride, pyromellitic anhydride, trimellitic anhydride, benzophenonetetracarboxylic anhydride, ethylene glycol bis-anhydro trimellitate, and glycerol tris-anhydro trimellitate.

### Method of Preparing a Composition for Forming a Film

In the preparation of the composition for forming a film, the respective components may be only mixed and stirred by a typical method and may be dispersed or mixed using a disperser such as a dissolver, a homogenizer, or a triple roll mill if necessary. Further, after mixing the components, the components may be filtered using a mesh or a membrane filter.

### Method of Forming Film

In the method of forming a film according to the present invention, a film is formed using the composition for forming a film on a substrate in which the maximum radius among the radii from the center to the outer periphery is 150 mm or more such that the thickness of the film becomes 50 μm or more with a spin coating method. Here, the expression “the maximum radius among the radii from the center to the outer periphery” means the longest radius among the radii from the center of rotation of the substrate to the outer periphery of the substrate in a case of performing spin coating. When the shape of the substrate is circular, “the maximum radius among the radii from the center to the outer periphery” becomes the radius of the circle, and when the shape of the substrate is rectangular or square, “the maximum radius among the radii from the center to the outer periphery” becomes the length of the half diagonal line.

The type of the substrate is not particularly limited, and a conventional substrate in the related art can be used, and a substrate for electronic components or a substrate in which a predetermined wiring pattern is formed on the substrate for electronic components can be exemplified. Examples of the material of the substrate may include a metallic substrate such as silicon, silicon nitride, titanium, tantalum, palladium, titanium tungsten, copper, chromium, iron, or aluminum or a glass substrate. As the material of the wiring pattern, copper, solder, chromium, aluminum, nickel, or gold may be used.

The composition for forming a film is coated on the substrate using the spin coating method to form a film with a desired thickness such that the thickness of the film becomes 50 μm or more. After the spin coating, the film is heated and a solvent (A) remained in the film may be removed as needed. The heating temperature thereof varies due to the kind, the blending ratio of each component in the composition for forming a film, or the thickness of the film, but the heating temperature is generally 80° C. to 180° C. and preferably 100° C. to 160° C. for approximately 1 to 30 minutes. The heating method may be multiple baking, in which baking may be performed over multiple stages.

In general, when a film is formed on a large substrate such that the maximum radius among radii from the center to the outer periphery of the substrate becomes 150 mm or more using a spin coating method, the formation of a film having a uniform thickness of 50 μm or more is difficult to be performed because the number of rotations of the substrate is set to be low. However, in the method for forming a film according to the present invention, since a film is formed with the above-described method using the composition for forming a film, which has the above-described particular composition, a film having a uniform thickness of 50 μm or more can be formed on a large substrate.

When the film to be formed in the above-described way is patterned, a conventional method is adopted according to the constitution of the composition for forming a film. For example, when the composition for forming a film contains a resin whose solubility in alkali increases under the action of acid and a photoacid generator, a pattern can be formed by selectively exposing the film via a mask having a predetermined pattern, and developing the exposed film with an alkaline developer solution.

At the time of exposure, as the source of radioactive rays, a low pressure mercury lamp, a high pressure mercury lamp, an ultrahigh pressure mercury lamp, a metal halide lamp, or an argon gas laser can be used. In addition, radioactive rays include microwaves, infrared rays, visible rays, ultraviolet rays, X-rays, γ-rays, electron beams, proton beams, neutron beams, and ion beams. The irradiation amount of radioactive rays vary due to the constitution of the composition for forming a film or the thickness of the film, and for example, the irradiation amount thereof is 100 mJ/cm² to 10,000 mJ/cm² in a case in which an ultrahigh pressure mercury lamp is used.

After the exposure, diffusion of the acid accelerates by heating the film using a conventional method and the alkali solubility of the coated layer of the exposed portion may be changed.

As the alkaline developer solution used for developing after the exposure, for example, an aqueous solution of alkalis such as sodium hydroxide, potassium hydroxide, sodium carbonate, sodium silicate, sodium metasilicate, ammonia water, ethylamine, n-propylamine, diethylamine, di-n-propylamine, triethylamine, methyldiethylamine, dimethylethanolamine, triethanolamine, tetramethylammoniumhydroxide, tetraethylammoniumhydroxide, pyrrol, piperidine, 1,8-diazabicyclo[5,4,0]-7-undecene, or 1,5-diazabicylo[4,3,0]-5-nonane, may be used. In addition, an aqueous solution in which an appropriate amount of a water-soluble organic solvent such as methanol or ethanol or a surfactant is added to the alkaline aqueous solution can be used as a developer solution.

The developing time varies due to the constitution of the composition for forming a film or the thickness of the film, but the developing time is generally 1 minute to 30 minutes. As the developing method, any of a liquid-filling method, a dipping method, a paddle method, or a spray developing method may be used.

The film is washed with flowing water for 30 seconds to 90 seconds after developing, and dried using an air gun or an oven. In this way, a patterned film can be produced.

### EXAMPLES

Hereinafter, examples of the present invention will be described, but the scope of the present invention is not limited thereto.

### Examples 1 to 9 and Comparative Examples 1 to 6

In Examples and Comparative Examples, the following resins were used. In the following formula representing the structures of resins, the numbers written at the lower right of the constituent units mean mass ratios (% by mass) of each constituent unit to the mass of the resins.

Resin 1: cresol novolac resin (m-cresol:p-cresol ratio=60:40, mass average molecular weight: 16,400)

Resin 2: cresol novolac resin (m-cresol:p-cresol ratio=36:64, a mixture having a mass ratio of 1:1 of a resin having a mass average molecular weight of 5,200 to a resin having a mass average molecular weight of 7,000)

Resin 3: resin in the following formula (I) (mass average molecular weight: 2,500)

Resin 4: resin in the following formula (II) (mass average molecular weight: 240,000)

Resin 5: resin in the following formula (III) (mass average molecular weight: 40,000)

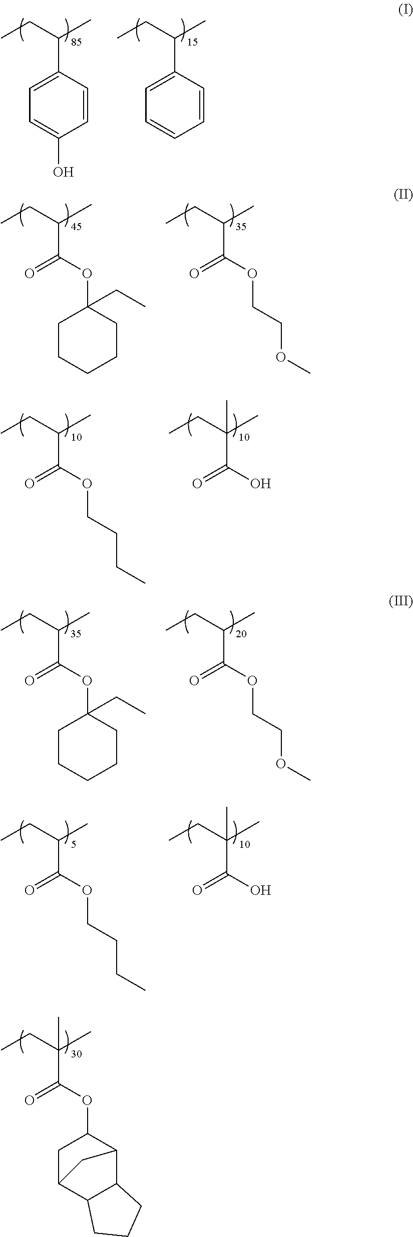

In the Examples and Comparative Examples, the following solvents were used. The vapor pressures and the viscosities of the solvents are listed in Table 1. The viscosities listed in Table 1 are viscosities measured by a Cannon-Fenske viscometer at 25° C. The vapor pressures listed in Table 1 are vapor pressures measured at 25° C.

MA: 3-methoxybutyl acetate

HP: 2-heptanone

PM: propylene glycol monomethyl ether acetate

EL: ethyl lactate

PE: propylene glycol monomethyl ether

TABLE 1

| | Vapor pressure (kPa) | Viscosity (mPa · s) |
|---|---|---|
| MA | 0.37 | 1.2 |
| HP | 0.26 | 0.8 |
| PM | 0.51 | 1.1 |
| EL | 0.36 | 2.7 |
| PE | 1.20 | 2.0 |

The composition for forming a film used in each Example and Comparative Example was prepared by mixing 50 parts by mass of the resin of the kind described in Table 2 and 50 parts by mass of the solvent of the kind described in Table 2. The obtained composition for forming a film was coated on a silicon substrate (scrubline process in a lattice shape with intervals of 2 cm, depth: 80 μm) having a diameter of 8 inches or 12 inches using a spin coater to form a film with a thickness of 50 μm. The film was prebaked at 140° C. for 5 minutes.

Uniformity A, uniformity B, and bubble inclusion of the film formed in such a way were evaluated according to the following method. The evaluation results are listed in Table 2.

### [Uniformity A]

An arbitrary diameter was set on the film formed on the silicon substrate having a diameter of 8 inches or 12 inches. 49 measurement points including 2 points at both terminals of the diameter and 47 points on the diameter were set on the diameter such that the intervals of the adjacent measurement points became equivalent. With regard to the 49 measurement points, the thickness of the formed film was measured. The value of dispersion (σ) which was acquired from the measured thicknesses of 49 points was set as a value of the uniformity A.

### [Uniformity B]

An arbitrary diameter was set on the film formed on the silicon substrate having a diameter of 12 inches. 59 measurement points including 2 points at both terminals of the diameter and 57 points on the diameter were set on the diameter such that the intervals of the adjacent measurement points became equivalent. In regard to the 59 measurement points, the thickness of the formed film was measured. From the obtained measurement results, an average value A of the thickness at measurement points which were present inside a circle whose radius from the center of the substrate was 5 mm and an average value B of the thickness at all the measurement points were acquired. The value of the average value A to the average value B was set as a value of the uniformity B. Further, in regard to Comparative Examples 1 to 3, 5, and 6, since ununiformity of the film thickness was obvious from the Table of the uniformity A of the 12 inch substrate, the evaluation of the uniformity B was not performed.

### [Bubble Inclusion]

The number of bubbles having a diameter of 100 μm or more on the film formed on the 8 inch substrate was visually counted. The number of bubbles is listed in Table 2.

TABLE 2

| | | | Uniformity A | | Uniformity B | Bubble inclusion | |
|---|---|---|---|---|---|---|---|
| | Type of | Type of | Diameter of substrate | | Diameter of substrate | Diameter of substrate | |
| | resin | solvent | 8 inches | 12 inches | 12 inches | 8 inches | 12 inches |
| Example 1 | Resin 1 | MA | 1.9 | 3.6 | 1.1 | 23 | 250 |
| Example 2 | Resin 2 | MA | 1.3 | 2.7 | 1.2 | 13 | 200 |
| Example 3 | Resin 3 | MA | 1.5 | 2.9 | 1.0 | 48 | 300 |
| Example 4 | Resin 4 | MA | 0.3 | 0.6 | 1.0 | 4 | 5 |
| Example 5 | Resin 5 | MA | 1.9 | 3.7 | 1.0 | 3 | 200 |
| Example 6 | Resin 2 | HP | 0.4 | 0.9 | 1.0 | 3 | 4 |
| Example 7 | Resin 3 | HP | 1.6 | 3.3 | 1.0 | 19 | 150 |
| Example 8 | Resin 4 | HP | 1.4 | 2.8 | 1.1 | 2 | 1 |
| Example 9 | Resin 5 | HP | 0.9 | 1.7 | 1.1 | 5 | 400 |
| Comparative | Resin 1 | PM | 8.2 | 17.8 | — | 136 | 1000 or |
| Example 1 | | | | | | | more |
| Comparative | Resin 2 | PM | 7.5 | 14.9 | — | 68 | 600 |
| Example 2 | | | | | | | |
| Comparative | Resin 3 | PM | 9.9 | 19.1 | — | 258 | 1000 or |
| Example 3 | | | | | | | more |
| Comparative | Resin 5 | PM | 3.1 | 6.3 | 1.2 | 20 | 20 |
| Example 4 | | | | | | | |
| Comparative | Resin 2 | EL | 5.8 | 11.9 | — | 38 | 400 |
| Example 5 | | | | | | | |
| Comparative | Resin 2 | PE | 8.8 | 18.0 | — | 55 | 500 |
| Example 6 | | | | | | | |

According to Table 2, it is revealed that when the composition for forming a film containing a resin and a solvent in which the vapor pressure at 25° C. is 0.4 kPa or less and the viscosity measured by a Cannon-Fenske viscometer at 25° C. is 1.5 mPa·S or less is used, a thick film having a uniform thickness of 50 μm or more can be formed using a spin coating method even if a 12 inch (300 mm) type substrate is used.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A method of forming a film, comprising:
forming a film on a substrate by coating a composition for forming a film containing a solvent (A) and a resin (B) by a spin coating method,
wherein a maximum radius among the radii from the center to the outer periphery of the substrate is 150 mm or more and a thickness of the film is 50 μm or more,
a vapor pressure of the solvent at 25° C. is 0.4 kPa or less, and
a viscosity of the solvent measured by a Cannon-Fenske viscometer at 25° C. is 1.5 mPa·s or less.

2. A substrate with a film, comprising a film formed by the method of forming a film according to claim 1.

3. The method of forming a film according to claim 1, wherein the solvent (A) is selected from the group consisting of 3-methoxybutyl acetate (MA), 2-heptanone (HP), dipropylene glycol dimethyl ether, and dipropylene glycol methyl-n-propyl ether.

4. The method of forming a film according to claim 1, wherein a solid content concentration of the composition for forming a film is 45% by mass to 65% by mass.
